(19) United States
(12) Patent Application Publication
(10) Pub. No.: US 2025/0184096 A1
(43) Pub. Date: Jun. 5, 2025

(54) UNIFIED TRANSMISSION CONFIGURATION INDICATOR STATE INDICATION FOR SINGLE-FREQUENCY NETWORKS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/843,944

(22) PCT Filed: Apr. 24, 2022
(86) PCT No.: PCT/CN2022/088800

§ 371 Date: Sep. 4, 2024

(51) Int. Cl. H04L 5/00; H04W 72/232

(52) U.S. Cl. CPC H04L 5/0091; H04L 5/0048; H04W 72/232

(57) ABSTRACT

Methods, systems, and devices for wireless communications are described. Some wireless communications systems may support one or more single-frequency network (SFN) communication schemes for applying unified transmission configuration indicator (TCI) states to SFN transmissions. For example, a network entity may transmit a first control message to a UE. The first control message may include one or more parameters each indicative of an SFN communication scheme applicable to one or more of a first physical downlink channel or a second physical downlink channel. The network entity may transmit a second control message that activates one or more TCI states for the UE. The UE may determine which of the activated TCI states to apply for reception of the first physical downlink channel and the second physical downlink channel based on the one or more SFN communication schemes indicated via the first control message.

### CROSS REFERENCE

The present application is a 371 national phase filing of International PCT Application No. PCT/CN2022/088800 by YUAN et al., entitled “UNIFIED TRANSMISSION CONFIGURATION INDICATOR STATE INDICATION FOR SINGLE-FREQUENCY NETWORKS,” filed Apr. 24, 2022, which is assigned to the assignee hereof, and which is expressly incorporated by reference in its entirety herein.

### FIELD OF TECHNOLOGY

The following relates to wireless communication, including unified transmission configuration indicator (TCI) state indication for single-frequency networks (SFNs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may communicate with multiple transmission and reception points (TRPs), which may be referred to as radio heads or access points within a network. The TRPs may support single-frequency network (SFN) communications, in which each TRP may transmit a same signal to the UE.

### SUMMARY

The described techniques relate to improved methods, systems, devices, and apparatuses that support unified transmission configuration indicator (TCI) state indication for single-frequency networks (SFNs). For example, the described techniques may provide for improved unified TCI state indications for SFN communications from multiple transmission and reception points (TRPs). A network entity may transmit a first control message to a user equipment (UE) to indicate or configure one or more SFN communication schemes. The UE may use the indicated SFN communication scheme(s) to determine how to apply one or more unified TCI states for receiving signals transmitted in accordance with SFN communications, such as a signal that is transmitted via the same or similar resources by multiple TRPs. In some aspects, the first control message may include a parameter that indicates an SFN communication scheme applicable to both a first physical downlink channel and a second physical downlink channel. The network entity may subsequently transmit a second control message that indicates a set of one or more TCI states for the UE, where the TCI states may be unified TCI states. The UE may receive the first and second physical downlink channels from the network entity in accordance with SFN communications and based on the indicated SFN communication scheme. For example, the UE may use a subset or all of the indicated TCI states to receive the first and second physical downlink channels, where a quantity of the TCI states that are used, a quantity of quasi co-location (QCL) parameters associated with each TCI state, or both, may be based on the indicated SFN communication scheme.

In some other aspects, the first control message may indicate a first parameter associated with a first SFN communication scheme applicable to a first physical downlink channel, a second parameter associated with a second SFN communication scheme applicable to a second physical downlink channel, or both. The network entity may subsequently transmit the second control message to indicate one or more TCI states for the UE, which may be unified TCI states. The UE may receive the first and second physical downlink channels from the network entity in accordance with SFN communications and based on which SFN communication scheme(s) are indicated. For example, if the first SFN communication scheme is indicated and the second SFN communication scheme is not indicated, the UE may receive the first physical downlink channel using all of the TCI states activated by the second control message and the UE may receive the second physical downlink channel using a subset of the TCI states indicated by the second control message, or vice versa. If both of the first and second SFN communication schemes are indicated by the first control message, the UE may use all of the TCI states indicated by the second control message to receive both physical downlink channels. In some aspects, the second control message may indicate a TCI state selection parameter that indicates which TCI state the UE is to use to receive the second physical downlink channel, and the UE may use the indicated TCI state to receive the second physical downlink channel accordingly. A network entity may thereby transmit, to a UE, an indication of unified TCI states and an SFN communication scheme. The UE may use the indicated TCI states and the SFN communication scheme to receive a downlink channel transmitting in accordance with SFN communications from multiple TRPs, which may improve communication reliability and throughput.

A method for wireless communication at a UE is described. The method may include receiving a first control message including a parameter that indicates an SFN communication scheme applicable to both a first physical downlink channel and a second physical downlink channel, receiving a second control message indicating a set of one or more TCI states from a set of multiple TCI states, and receiving the first physical downlink channel and the second physical downlink channel using a subset of one or more TCI states, the subset of one or more TCI states selected from the set of one or more TCI states based on the SFN communication scheme indicated by the parameter.

An apparatus for wireless communication at a UE is described. The apparatus may include a processor, memory coupled with the processor, and instructions stored in the memory. The instructions may be executable by the processor to cause the apparatus to receive a first control message including a parameter that indicates an SFN communication scheme applicable to both a first physical downlink channel and a second physical downlink channel, receive a second control message indicating a set of one or more TCI states from a set of multiple TCI states, and receive the first physical downlink channel and the second physical downlink channel using a subset of one or more TCI states, the subset of one or more TCI states selected from the set of one or more TCI states based on the SFN communication scheme indicated by the parameter.

Another apparatus for wireless communication at a UE is described. The apparatus may include means for receiving a first control message including a parameter that indicates an SFN communication scheme applicable to both a first physical downlink channel and a second physical downlink channel, means for receiving a second control message indicating a set of one or more TCI states from a set of multiple TCI states, and means for receiving the first physical downlink channel and the second physical downlink channel using a subset of one or more TCI states, the subset of one or more TCI states selected from the set of one or more TCI states based on the SFN communication scheme indicated by the parameter.

A non-transitory computer-readable medium storing code for wireless communication at a UE is described. The code may include instructions executable by a processor to receive a first control message including a parameter that indicates an SFN communication scheme applicable to both a first physical downlink channel and a second physical downlink channel, receive a second control message indicating a set of one or more TCI states from a set of multiple TCI states, and receive the first physical downlink channel and the second physical downlink channel using a subset of one or more TCI states, the subset of one or more TCI states selected from the set of one or more TCI states based on the SFN communication scheme indicated by the parameter.

In some examples of the method, apparatuses, and non-transitory computer-readable medium described herein, the SFN scheme may correspond to a first SFN scheme of a set of multiple SFN schemes, and receiving the first physical downlink channel and the second physical downlink channel may include operations, features, means, or instructions for receiving both the first physical downlink channel and the second physical downlink channel using each TCI state of the set of one or more TCI states indicated by the second control message based on the first SFN communication scheme.

In some examples of the method, apparatuses, and non-transitory computer-readable medium described herein, a codepoint indicated by the second control message may include two TCI states from the set of multiple TCI states.

In some examples of the method, apparatuses, and non-transitory computer-readable medium described herein, the SFN scheme may correspond to a second SFN scheme of a set of multiple SFN schemes, receiving the first physical downlink channel and the second physical downlink channel may include operations, features, means, or instructions for receiving both the first physical downlink channel and the second physical downlink channel using a first set of QCL parameters associated with a first TCI state of the set of one or more TCI states and a second set of one or more QCL parameters associated with a second TCI state of the set of one or more TCI states based on the second SFN communication scheme, where the second set of one or more QCL parameters excludes one or more QCL parameters.

In some examples of the method, apparatuses, and non-transitory computer-readable medium described herein, the first set of QCL parameters may include a doppler shift parameter, a doppler spread parameter, a delay shift parameter, a delay spread parameter, or any combination thereof and the second set of one or more QCL parameters excludes one or more parameters of the first set of QCL parameters.

In some examples of the method, apparatuses, and non-transitory computer-readable medium described herein, a codepoint indicated by the second control message may include two TCI states from the set of multiple TCI states.

In some examples of the method, apparatuses, and non-transitory computer-readable medium described herein, receiving the first physical downlink channel and the second physical downlink channel may include operations, features, means, or instructions for receiving both the first physical downlink channel and the second physical downlink channel using a single TCI state based on the second control message indicating the single TCI state.

Some examples of the method, apparatuses, and non-transitory computer-readable medium described herein may further include operations, features, means, or instructions for transmitting a capability message indicating a capability of the UE to support SFN communications with multiple TRPs, where the second control message indicates a codepoint that includes one or more TCI states from the set of multiple TCI states based on the capability message.

In some examples of the method, apparatuses, and non-transitory computer-readable medium described herein, the first control message may include a radio resource control (RRC) message and the second control message may include downlink control information (DCI).

In some examples of the method, apparatuses, and non-transitory computer-readable medium described herein, receiving the first physical downlink channel and the second physical downlink channel may include operations, features, means, or instructions for receiving both the first physical downlink channel and the second physical downlink channel from two or more TRPs in accordance with the SFN communication scheme.

In some examples of the method, apparatuses, and non-transitory computer-readable medium described herein, the first physical downlink channel includes a physical downlink control channel (PDCCH) and the second physical downlink channel includes a physical downlink shared channel (PDSCH).

A method for wireless communication at a UE is described. The method may include receiving a first control message indicating a first parameter associated with a first SFN communication scheme applicable to a first physical downlink channel, or a second parameter associated with a second SFN communication scheme applicable to a second physical downlink channel, or both, receiving a second control message that indicates one or more TCI states from a set of TCI states, and receiving each of the first physical downlink channel and the second physical downlink channel using at least one TCI state of the one or more TCI states based on the first SFN communication scheme indicated by the first parameter, the second SFN communication scheme indicated by the second parameter, or both.

An apparatus for wireless communication at a UE is described. The apparatus may include a processor, memory coupled with the processor, and instructions stored in the memory. The instructions may be executable by the processor to cause the apparatus to receive a first control message indicating a first parameter associated with a first SFN communication scheme applicable to a first physical downlink channel, or a second parameter associated with a second SFN communication scheme applicable to a second physical downlink channel, or both, receive a second control message that indicates one or more TCI states from a set of TCI states, and receive each of the first physical downlink channel and the second physical downlink channel using at least one TCI state of the one or more TCI states based on the first SFN communication scheme indicated by the first parameter, the second SFN communication scheme indicated by the second parameter, or both.

Another apparatus for wireless communication at a UE is described. The apparatus may include means for receiving a first control message indicating a first parameter associated with a first SFN communication scheme applicable to a first physical downlink channel, or a second parameter associated with a second SFN communication scheme applicable to a second physical downlink channel, or both, means for receiving a second control message that indicates one or more TCI states from a set of TCI states, and means for receiving each of the first physical downlink channel and the second physical downlink channel using at least one TCI state of the one or more TCI states based on the first SFN communication scheme indicated by the first parameter, the second SFN communication scheme indicated by the second parameter, or both.

A non-transitory computer-readable medium storing code for wireless communication at a UE is described. The code may include instructions executable by a processor to receive a first control message indicating a first parameter associated with a first SFN communication scheme applicable to a first physical downlink channel, or a second parameter associated with a second SFN communication scheme applicable to a second physical downlink channel, or both, receive a second control message that indicates one or more TCI states from a set of TCI states, and receive each of the first physical downlink channel and the second physical downlink channel using at least one TCI state of the one or more TCI states based on the first SFN communication scheme indicated by the first parameter, the second SFN communication scheme indicated by the second parameter, or both.

In some examples of the method, apparatuses, and non-transitory computer-readable medium described herein, the first control message may indicate the first parameter and the second parameter, and receiving each of the first physical downlink channel and the second physical downlink channel may include operations, features, means, or instructions for receiving the first physical downlink channel using all of the one or more TCI states based on the first SFN communication scheme indicated by the first parameter and receiving the second physical downlink channel using all of the one or more TCI states based on the second SFN communication scheme indicated by the second parameter.

In some examples of the method, apparatuses, and non-transitory computer-readable medium described herein, a codepoint indicated by the second control message may include two TCI states from the set of TCI states.

In some examples of the method, apparatuses, and non-transitory computer-readable medium described herein, the first control message may indicate the first parameter and the second parameter, and receiving each of the first physical downlink channel and the second physical downlink channel may include operations, features, means, or instructions for receiving the first physical downlink channel using all of the one or more TCI states based on the first SFN communication scheme indicated by the first parameter and receiving the second physical downlink channel using a subset of the one or more TCI states based on the second SFN communication scheme indicated by the second parameter and a TCI state selection parameter, where the second control message indicates the TCI state selection parameter.

In some examples of the method, apparatuses, and non-transitory computer-readable medium described herein, a codepoint indicated by the second control message may include two TCI states from the set of TCI states and the subset includes one or both of the two TCI states. In some examples of the method, apparatuses, and non-transitory computer-readable medium described herein, the TCI state selection parameter may indicate a single TCI state or two TCI states to be applied for receipt of the second physical downlink channel.

Some examples of the method, apparatuses, and non-transitory computer-readable medium described herein may further include operations, features, means, or instructions for receiving a third control message that indicates a threshold time period for determining whether to include one or more TCI states indicated by the TCI state selection parameter in the subset of TCI states for receipt of the second physical downlink channel and determining that a time period between a first time at which the second control message may be received and a current time may be greater than or equal to the threshold time period, where the subset of TCI states includes the one or more TCI states indicated by the TCI state selection parameter based on the time period being greater than or equal to the threshold time period.

Some examples of the method, apparatuses, and non-transitory computer-readable medium described herein may further include operations, features, means, or instructions for receiving a third control message that indicates a threshold time period for determining whether to include one or more TCI states indicated by the TCI state selection parameter in the subset of TCI states for receipt of the second physical downlink channel and determining that a time period between a first time at which the second control message may be received and a current time may be less than the threshold time period, where the subset of TCI states includes one or more default TCI states based on the time period being less than the threshold time period, the one or more default TCI states configured for the second physical downlink channel.

In some examples of the method, apparatuses, and non-transitory computer-readable medium described herein, the first control message may indicate the first parameter and exclude the second parameter, and receiving each of the first physical downlink channel and the second physical downlink channel may include operations, features, means, or instructions for receiving the first physical downlink channel using all of the one or more TCI states indicated by the second control message based on the first SFN communication scheme indicated by the first parameter and receiving the second physical downlink channel using a subset of TCI states based on exclusion of the second parameter from the first control message.

In some examples of the method, apparatuses, and non-transitory computer-readable medium described herein, receiving each of the first physical downlink channel and the second physical downlink channel may include operations, features, means, or instructions for receiving both the first physical downlink channel and the second physical downlink channel using a single TCI state based on the second control message indicating the single TCI state.

Some examples of the method, apparatuses, and non-transitory computer-readable medium described herein may further include operations, features, means, or instructions for transmitting a capability message indicating a capability of the UE to support SFN communications with multiple TRPs, where the second control message indicates two or more TCI states based on the capability message.

In some examples of the method, apparatuses, and non-transitory computer-readable medium described herein, the first control message includes an RRC message and the second control message includes DCI. In some examples of the method, apparatuses, and non-transitory computer-readable medium described herein, receiving each of the first physical downlink channel and the second physical downlink channel may include operations, features, means, or instructions for receiving both the first physical downlink channel and the second physical downlink channel from two or more TRPs.

In some examples of the method, apparatuses, and non-transitory computer-readable medium described herein, the first physical downlink channel includes a first type of physical downlink channel and the second physical downlink channel includes a second type of physical downlink channel that may be different than the first type of physical downlink channel, each of the first type and the second type selected from one of a PDCCH or a PDSCH.

A method for wireless communication at a network entity is described. The method may include transmitting a first control message including a parameter that indicates an SFN communication scheme applicable to both a first physical downlink channel and a second physical downlink channel, transmitting a second control message indicating a set of one or more TCI states from a set of multiple TCI states, and transmitting the first physical downlink channel and the second physical downlink channel in accordance with a subset of one or more TCI states, the subset of one or more TCI states selected from the set of one or more TCI states based on the SFN communication scheme indicated by the parameter.

An apparatus for wireless communication at a network entity is described. The apparatus may include a processor, memory coupled with the processor, and instructions stored in the memory. The instructions may be executable by the processor to cause the apparatus to transmit a first control message including a parameter that indicates an SFN communication scheme applicable to both a first physical downlink channel and a second physical downlink channel, transmit a second control message indicating a set of one or more TCI states from a set of multiple TCI states, and transmit the first physical downlink channel and the second physical downlink channel in accordance with a subset of one or more TCI states, the subset of one or more TCI states selected from the set of one or more TCI states based on the SFN communication scheme indicated by the parameter.

Another apparatus for wireless communication at a network entity is described. The apparatus may include means for transmitting a first control message including a parameter that indicates an SFN communication scheme applicable to both a first physical downlink channel and a second physical downlink channel, means for transmitting a second control message indicating a set of one or more TCI states from a set of multiple TCI states, and means for transmitting the first physical downlink channel and the second physical downlink channel in accordance with a subset of one or more TCI states, the subset of one or more TCI states selected from the set of one or more TCI states based on the SFN communication scheme indicated by the parameter.

A non-transitory computer-readable medium storing code for wireless communication at a network entity is described. The code may include instructions executable by a processor to transmit a first control message including a parameter that indicates an SFN communication scheme applicable to both a first physical downlink channel and a second physical downlink channel, transmit a second control message indicating a set of one or more TCI states from a set of multiple TCI states, and transmit the first physical downlink channel and the second physical downlink channel in accordance with a subset of one or more TCI states, the subset of one or more TCI states selected from the set of one or more TCI states based on the SFN communication scheme indicated by the parameter.

In some examples of the method, apparatuses, and non-transitory computer-readable medium described herein, the SFN communication scheme may correspond to a first SFN communication scheme of a set of multiple SFN communication schemes, and transmitting the first physical downlink channel and the second physical downlink channel may include operations, features, means, or instructions for transmitting both the first physical downlink channel and the second physical downlink channel in accordance with each TCI state of the set of one or more TCI states indicated by the second control message based on the first SFN communication scheme.

In some examples of the method, apparatuses, and non-transitory computer-readable medium described herein, the SFN communication scheme may correspond to a second SFN communication scheme of a set of multiple SFN communication schemes, and transmitting the first physical downlink channel and the second physical downlink channel may include operations, features, means, or instructions for transmitting both the first physical downlink channel and the second physical downlink channel in accordance with a first set of QCL parameters associated with a first TCI state of the set of one or more TCI states and a second set of one or more QCL parameters associated with a second TCI state of the set of one or more TCI states based on the second SFN communication scheme, where the second set of one or more QCL parameters may exclude one or more QCL parameters.

In some examples of the method, apparatuses, and non-transitory computer-readable medium described herein, transmitting the first physical downlink channel and the second physical downlink channel may include operations, features, means, or instructions for transmitting both the first physical downlink channel and the second physical downlink channel in accordance with a single TCI state based on the second control message indicating the single TCI state.

Some examples of the method, apparatuses, and non-transitory computer-readable medium described herein may further include operations, features, means, or instructions for receiving, from a UE, a capability message indicating a capability of the UE to support SFN communications with multiple TRPs, where the second control message indicates one or more TCI states from the set of multiple TCI states based on the capability message.

In some examples of the method, apparatuses, and non-transitory computer-readable medium described herein, transmitting the first physical downlink channel and the second physical downlink channel may include operations, features, means, or instructions for transmitting both the first physical downlink channel and the second physical downlink channel from two or more TRPs of the network entity in accordance with the SFN communication scheme.

A method for wireless communication at a network entity is described. The method may include transmitting a first control message indicating a first parameter associated with a first SFN communication scheme applicable to a first physical downlink channel, or a second parameter associated with a second SFN communication scheme applicable to a second physical downlink channel, or both, transmitting a second control message that indicates one or more TCI states from a set of TCI states, and transmitting each of the first physical downlink channel and the second physical downlink channel in accordance with at least one TCI state of the one or more TCI states based on the first SFN communication scheme indicated by the first parameter, the second SFN communication scheme indicated by the second parameter, or both.

An apparatus for wireless communication at a network entity is described. The apparatus may include a processor, memory coupled with the processor, and instructions stored in the memory. The instructions may be executable by the processor to cause the apparatus to transmit a first control message indicating a first parameter associated with a first SFN communication scheme applicable to a first physical downlink channel, or a second parameter associated with a second SFN communication scheme applicable to a second physical downlink channel, or both, transmit a second control message that indicates one or more TCI states from a set of TCI states, and transmit each of the first physical downlink channel and the second physical downlink channel in accordance with at least one TCI state of the one or more TCI states based on the first SFN communication scheme indicated by the first parameter, the second SFN communication scheme indicated by the second parameter, or both.

Another apparatus for wireless communication at a network entity is described. The apparatus may include means for transmitting a first control message indicating a first parameter associated with a first SFN communication scheme applicable to a first physical downlink channel, or a second parameter associated with a second SFN communication scheme applicable to a second physical downlink channel, or both, means for transmitting a second control message that indicates one or more TCI states from a set of TCI states, and means for transmitting each of the first physical downlink channel and the second physical downlink channel in accordance with at least one TCI state of the one or more TCI states based on the first SFN communication scheme indicated by the first parameter, the second SFN communication scheme indicated by the second parameter, or both.

A non-transitory computer-readable medium storing code for wireless communication at a network entity is described. The code may include instructions executable by a processor to transmit a first control message indicating a first parameter associated with a first SFN communication scheme applicable to a first physical downlink channel, or a second parameter associated with a second SFN communication scheme applicable to a second physical downlink channel, or both, transmit a second control message that indicates one or more TCI states from a set of TCI states, and transmit each of the first physical downlink channel and the second physical downlink channel in accordance with at least one TCI state of the one or more TCI states based on the first SFN communication scheme indicated by the first parameter, the second SFN communication scheme indicated by the second parameter, or both.

In some examples of the method, apparatuses, and non-transitory computer-readable medium described herein, the first control message may indicate the first parameter and the second parameter and transmitting each of the first physical downlink channel and the second physical downlink channel may include operations, features, means, or instructions for transmitting the first physical downlink channel in accordance with all of the one or more TCI states based on the first SFN communication scheme indicated by the first parameter and transmitting the second physical downlink channel in accordance with all of the one or more TCI states based on the second SFN communication scheme indicated by the second parameter.

In some examples of the method, apparatuses, and non-transitory computer-readable medium described herein, the first control message may indicate the first parameter and the second parameter and transmitting each of the first physical downlink channel and the second physical downlink channel may include operations, features, means, or instructions for transmitting the first physical downlink channel in accordance with all of the one or more TCI states based on the first SFN communication scheme indicated by the first parameter and transmitting the second physical downlink channel in accordance with a subset of the one or more TCI states based on the second SFN communication scheme indicated by the second parameter and a TCI state selection parameter, where the second control message indicates the TCI state selection parameter.

Some examples of the method, apparatuses, and non-transitory computer-readable medium described herein may further include operations, features, means, or instructions for transmitting a third control message that indicates a threshold time period for determining whether to include one or more TCI states indicated by the TCI state selection parameter in the subset of TCI states for transmission of the second physical downlink channel and determining that a time period between a first time at which the second control message may be received and a current time may be greater than or equal to the threshold time period, where the subset of TCI states includes the one or more TCI states indicated by the TCI state selection parameter based on the time period being greater than or equal to the threshold time period.

Some examples of the method, apparatuses, and non-transitory computer-readable medium described herein may further include operations, features, means, or instructions for transmitting a third control message that indicates a threshold time period for determining whether to include one or more TCI states indicated by the TCI state selection parameter in the subset of TCI states for transmission of the second physical downlink channel and determining that a time period between a first time at which the second control message may be received and a current time may be less than the threshold time period, where the subset of TCI states includes one or more default TCI states based on the time period being less than the threshold time period, the one or more default TCI states configured for the second physical downlink channel.

In some examples of the method, apparatuses, and non-transitory computer-readable medium described herein, the first control message may indicate the first parameter and may exclude the second parameter, and transmitting each of the first physical downlink channel and the second physical downlink channel may include operations, features, means, or instructions for transmitting the first physical downlink channel in accordance with all of the one or more TCI states indicated by the second control message based on the first SFN communication scheme indicated by the first parameter and transmitting the second physical downlink channel in accordance with a subset of TCI states based on exclusion of the second parameter from the first control message.

In some examples of the method, apparatuses, and non-transitory computer-readable medium described herein, receiving each of the first physical downlink channel and the second physical downlink channel may include operations, features, means, or instructions for transmitting both the first physical downlink channel and the second physical downlink channel in accordance with a single TCI state based on the second control message indicating the single TCI state.

### BRIEF DESCRIPTION OF THE DRAWINGS

FIG. 1 illustrates an example of a wireless communications system that supports unified transmission configuration indicator (TCI) state indication for single-frequency networks (SFNs) in accordance with one or more aspects of the present disclosure.

FIG. 2 illustrates an example of a wireless communications system that supports unified TCI state indication for SFNs in accordance with one or more aspects of the present disclosure.

FIGS. 3A and 3B illustrate examples of communication scheme diagrams that support unified TCI state indication for SFNs in accordance with one or more aspects of the present disclosure.

FIGS. 4A and 4B illustrate examples of communication scheme diagrams that support unified TCI state indication for SFNs in accordance with one or more aspects of the present disclosure.

FIG. 5 illustrates an example of a process flow in a system that supports unified TCI state indication for SFNs in accordance with one or more aspects of the present disclosure.

FIG. 6 illustrates an example of a process flow in a system that supports unified TCI state indication for SFNs in accordance with one or more aspects of the present disclosure.

FIGS. 7 and 8 show block diagrams of devices that support unified TCI state indication for SFNs in accordance with one or more aspects of the present disclosure.

FIG. 9 shows a block diagram of a communications manager that supports unified TCI state indication for SFNs in accordance with one or more aspects of the present disclosure.

FIG. 10 shows a diagram of a system including a device that supports unified TCI state indication for SFNs in accordance with one or more aspects of the present disclosure.

FIGS. 11 and 12 show block diagrams of devices that support unified TCI state indication for SFNs in accordance with one or more aspects of the present disclosure.

FIG. 13 shows a block diagram of a communications manager that supports unified TCI state indication for SFNs in accordance with one or more aspects of the present disclosure.

FIG. 14 shows a diagram of a system including a device that supports unified TCI state indication for SFNs in accordance with one or more aspects of the present disclosure.

FIGS. 15 through 20 show flowcharts illustrating methods that support unified TCI state indication for SFNs in accordance with one or more aspects of the present disclosure.

### DETAILED DESCRIPTION

Some wireless communications systems may support a unified transmission configuration indicator (TCI) framework, where different unified TCI types may be used to improve channel utilization between wireless devices. For example, a wireless communications system may support a joint downlink common TCI type to indicate a common beam for multiple downlink channels or a separate downlink common TCI type to indicate a common beam for one or more downlink channels.

A user equipment (UE) may communicate with one or more transmission and reception points (TRPs) within a network, where the one or more TRPs may be associated with a same network entity or different network entities. In some cases, two or more TRPs may each transmit a same signal to the UE using a different beam, which may be referred to as single-frequency network (SFN) communications (e.g., an “SFNed” transmission). In some cases, however, there may not be established procedures for applying unified TCI states for receipt of SFN communications. Such ambiguity may reduce throughput and reliability of the communications.

As described herein, a network entity may use or configure one or more parameters to indicate unified TCI states for SFN communications, which may improve coordination between devices, throughput, and reliability of communications. For example, the network entity may transmit a first control message (e.g., a radio resource control (RRC) message) that includes parameters indicative of one or more SFN communication schemes for a UE to use for receiving physical downlink channels transmitted in accordance with SFN communications from two or more TRPs. The network entity may transmit a message (e.g., a medium access control (MAC)-control element (MAC-CE)) that activates one or more unified TCI states for the UE. In such cases, one or more activated TCI states may be mapped to respective codepoints, which may be indicated to the UE via a second control message, such as downlink control information (DCI) (e.g., using a number of bits within a field of the DCI). The UE may determine which of the indicated TCI states to use for receiving one or more physical downlink channels transmitted in accordance with the SFN communications and based on the SFN communication scheme(s) indicated by the first control message. To use a given TCI state to receive a physical downlink channel, the UE may assume that the physical downlink channel (e.g., one or more demodulation reference signal (DMRS) ports of the physical downlink channel) is quasi co-located (QCLed) with one or more downlink reference signals associated with the given TCI state.

In some implementations, the first control message may indicate a joint parameter (e.g., sfnScheme) for an SFN communication scheme that is applicable to both a physical downlink shared channel (PDSCH) and a physical downlink control channel (PDCCH). If the joint parameter indicates a first SFN communication scheme (e.g., SFNschemeA) and a TCI codepoint indicated by the DCI includes two or more TCI states, the UE may use all of the indicated TCI states to receive the PDSCH and the PDCCH from two or more TRPs. If the joint parameter indicates a second scheme (e.g., SFNschemeB) and the TCI codepoint includes two or more TCI states, the UE may use a first set of quasi co-location (QCL) parameters associated with a first TCI state to receive the PDSCH and the PDCCH, and the UE may use a second set of QCL parameters associated with one or more second TCI states to receive the PDSCH and the PDCCH from the two or more TRPs. The first set of QCL parameters may include, for example, a delay shift parameter, a delay spread parameter, a doppler shift parameter, a doppler spread parameter, or any combination thereof. The second set of QCL parameters may exclude one or more of the QCL parameters.

In some other implementations, the first control message may indicate separate parameters for each downlink channel. For instance, the first control message may include a first parameter (e.g., sfnSchemepdsch) that indicates a first SFN scheme for the PDSCH, or a second parameter (e.g., sfnSchemepdcch) that indicates a second SFN scheme for the PDCCH, or both. If the first control message indicates one of the parameters but not the other and the TCI codepoint indicated by the DCI includes two or more TCI states, the UE may receive the physical downlink channel associated with the indicated parameter using all of the TCI states activated by the DCI, and the UE may receive the other physical downlink channel using a single TCI state. If the first control message indicates both of the parameters and the TCI codepoint indicated by the DCI includes two or more TCI states, the UE may receive each of the PDSCH and the PDCCH using all of the TCI states activated by the DCI. Additionally, or alternatively, the DCI may include a TCI state selection parameter that may indicate a TCI state for the UE to use for receipt of the PDSCH, and the UE may receive the PDSCH using the indicated TCI state accordingly. If the TCI codepoint indicated by the DCI includes a single TCI state, the UE may receive the PDSCH and the PDCCH using the single TCI state, regardless of the SFN communication scheme that is configured. The described techniques may thus provide for reduced ambiguity and improved utilization of unified TCI states for SFN communications.

Aspects of the disclosure are initially described in the context of wireless communications systems. Additional aspects are described in the with reference to communication scheme diagrams and process flows. Aspects of the disclosure are further illustrated by and described with reference to apparatus diagrams, system diagrams, and flowcharts that relate to unified TCI state indication for SFNs.

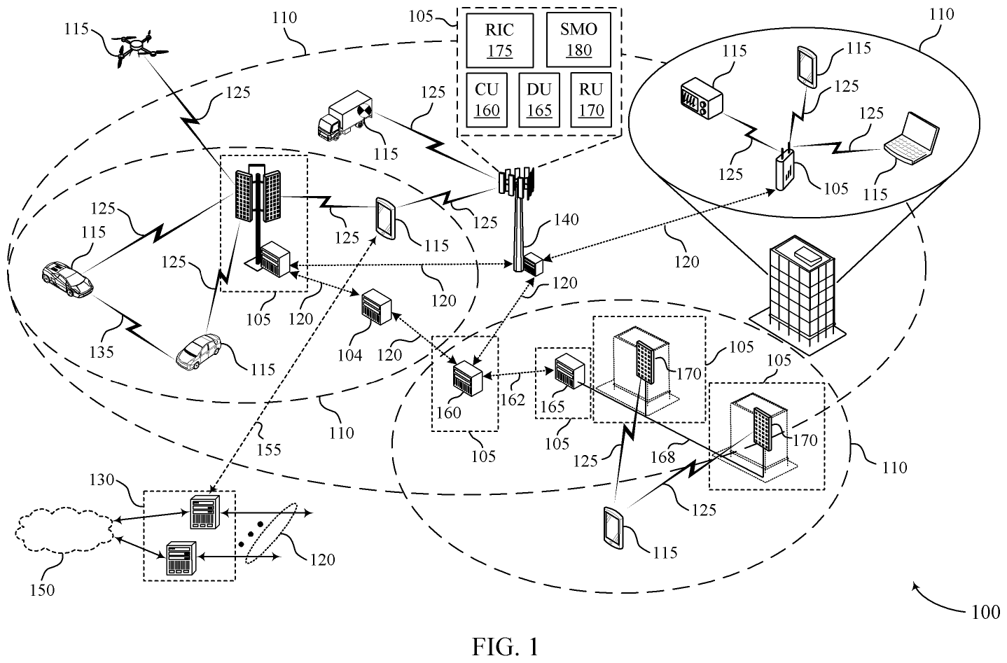

FIG. 1 illustrates an example of a wireless communications system 100 that supports unified TCI state indication for SFNs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to use a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to use a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support unified TCI state indication for SFNs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

A QCL relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being QCLed. QCLed signals may enable the UE 115 to derive the properties of a first signal (e.g., delay spread, delay shift, doppler spread, doppler shift, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficiently identify communications beams (e.g., without having to sweep through a large number of beams to identify the best beam (e.g., the beam having a highest signal quality)). In addition, QCL relationships may exist for both uplink and downlink transmissions and, in some cases, a QCL relationship may also be referred to as spatial relationship information.

In some examples, a TCI state may include one or more parameters associated with a QCL relationship between transmitted signals. For example, a network entity 105 may configure a QCL relationship that provides a mapping between a reference signal and antenna ports of another signal (e.g., a DMRS antenna port for PDCCH, a DMRS antenna port for PDSCH, a CSI-RS antenna port for CSI-RS, or the like), and the TCI state may be indicated to a UE 115 by the network entity 105. In some cases, a set of TCI states may be indicated to a UE 115 via RRC signaling, where some number of TCI states (e.g., a pool of 8 TCI states from of a total of 64 TCI states) may be configured via RRC and a subset of TCI states may be activated via a medium access control-control element (MAC-CE). Further, codepoints corresponding to activated TCI states in the MAC-CE may be indicated by DCI (e.g., within a CORESET), which may indicate a particular TCI state (and corresponding QCL relationship) for a channel or reference signal. The QCL relationship associated with the TCI state (and further established through higher-layer parameters) may provide the UE 115 with the QCL relationship for respective antenna ports and reference signals transmitted by the network entity 105.

In some examples of the wireless communications system 100, one or more wireless devices may support a unified TCI framework, where different types of TCIs (e.g., unified TCI types) may be used to improve channel utilization between wireless devices. For example, a first TCI type may be a separate downlink common TCI type that indicates a common beam for one or more downlink channels and/or reference signals, a second TCI type may be a separate uplink common TCI type that indicates a common beam for multiple uplink channels and/or reference signals, a third TCI type may be a joint TCI type that indicates a common beam for both downlink and uplink channels and/or reference signals, a fourth TCI type may be a separate downlink single TCI type that indicates a beam for a single downlink channel and/or reference signal, a fifth TCI type may be a separate uplink single TCI type that indicates a beam for a single uplink channel and/or reference signal, and a sixth TCI type may include spatial relation information (SRI) that indicates a beam for a single uplink channel and/or reference signal. In some examples, these various TCI types may be respective examples of one or more unified TCI types (e.g., TCI types associated with a unified TCI framework).

A UE 115 may communicate with one or more TRPs, (e.g., one or more RUs 170, radio units, radio heads, antenna panels, or the like) associated with one or more network entities 105. In some examples of multi-TRP communications, the UE 115 may use a same TCI type or different TCI types while communicating with multiple TRPs. For example, the network may indicate to the UE 115 to use a same TCI type for channels or reference signals, or both, associated with different TRPs (e.g., use the joint TCI type or a separate uplink/downlink TCI type for each TRP). In some examples, the network may indicate to the UE 115 to use different TCI types for channels or reference signals, or both, associated with different TRPs (e.g., use a first unified TCI type for channels/reference signals associated with a first TRP and a second unified TCI type different from the first unified TCI type for channels/reference signals associated with a second TRP).

In some examples, the wireless communications system 100 may support SFN communications from multiple TRPs. An SFN transmission may refer to a transmission from two or more TRPs, where each TRP may transmit the same signal on the same resources to a UE 115 such that to the UE 115, the combined transmission appears to be from a single TRP. In some aspects, transmitting data as an SFN transmission may improve reliability of the transmission as compared with transmission of the data from a single TRP. In some aspects, a single TCI state may be used for SFN transmissions (e.g., transparent SFN). For example, two or more TRPs may transmit a reference signal as a combined SFN transmission in accordance with a single TCI state. The UE 115 may receive the combined reference signal and determine a QCL for receiving the corresponding downlink transmission based on the TCI state. Additionally, or alternatively, two or more TCI states may be indicated to the UE 115 for SFN transmissions (e.g., non-transparent SFN). In such cases, each TRP may transmit a same reference signal but using a different TCI state. The UE 115 may receive the reference signals based on the different TCI states.

In some cases, a network entity 105 may transmit an indication of unified TCI states to a UE 115 that supports SFN communications with multiple TRPs. For example, the network entity 105 may transmit DCI that indicates a codepoint that includes two or more unified TCI states. The unified TCI state may be joint TCI state for downlink and uplink channels or separate TCI state for downlink channels. In some cases, however, the UE 115 may not know how to apply the unified TCI states for receiving an SFNed transmission from two or more TRPs.

Techniques described herein provide for improved unified TCI state indications for SFN transmissions from multiple TRPs. A network entity 105 may transmit a first control message (e.g., RRC message, MAC-CE, or some other type of control message) to a UE 115 to indicate or configure one or more SFN communication schemes. The UE 115 may use the indicated SFN communication scheme(s) to determine how to apply one or more unified TCI states for receipt of SFNed communications. In some aspects, the first control message may include a parameter that indicates an SFN communication scheme applicable to both a first physical downlink channel and a second physical downlink channel, which may represent examples of a PDSCH and a PDCCH, or some other types of physical downlink channels. The network entity 105 may subsequently transmit a second control message (e.g., DCI) that indicates a set of one or more TCI states for the UE 115. The UE 115 may receive the first and second physical downlink channels from the network entity 105 in accordance with SFN communications and based on the indicated SFN communication scheme. For example, the UE 115 may use a subset or all of the indicated TCI states to receive the first and second physical downlink channels, where a quantity of the TCI states that are used, a quantity of QCL parameters associated with each TCI state, or both, may be based on the indicated SFN communication scheme.

In some other aspects, the first control message may indicate a first parameter associated with a first SFN communication scheme applicable to a first physical downlink channel, a second parameter associated with a second SFN communication scheme applicable to a second physical downlink channel, or both. The network entity 105 may subsequently transmit the second control message to indicate one or more TCI states for the UE 115, which may be unified TCI states. The UE 115 may receive the first and second physical downlink channels from the network entity 105 in accordance with SFN communications and based on which SFN communication scheme(s) are indicated. For example, if the first SFN communication scheme is indicated and the second SFN communication scheme is not indicated, the UE 115 may receive the first physical downlink channel using all of the TCI states indicated by the second control message and the UE 115 may receive the second physical downlink channel using a subset of the TCI states indicated by the second control message, or vice versa. If both of the first and second SFN communication schemes are indicated by the first control message, the UE 115 may use all of the TCI states indicated by the second control message to receive both physical downlink channels. In some aspects, the second control message may indicate a TCI state selection parameter that indicates which TCI state the UE 115 is to use to receive the second physical downlink channel (e.g., a PDSCH), and the UE 115 may use the indicated TCI state to receive the second physical downlink channel accordingly. A network entity 105 may thereby transmit, to a UE 115, an indication of unified TCI states and an SFN communication scheme for applying the unified TCI states to one or more SFNed downlink channels. The UE 115 may use the indicated TCI states and the SFN communication scheme to receive the SFNed downlink channel from multiple TRPs, which may improve communication reliability and throughput.

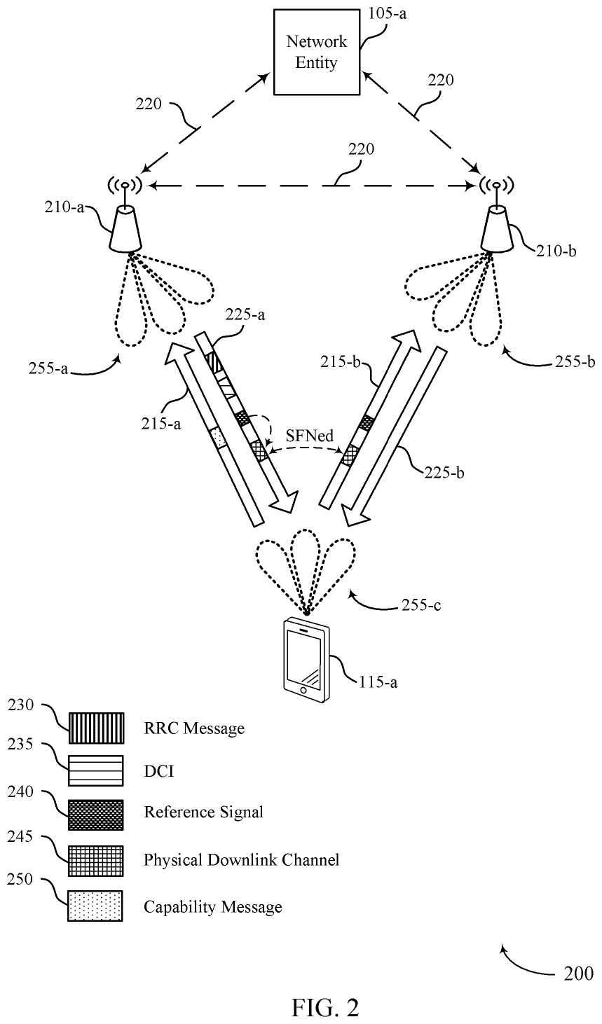

FIG. 2 illustrates an example of a wireless communications system 200 that supports unified TCI state indication for SFNs in accordance with one or more aspects of the present disclosure. The wireless communications system 200 may implement or be implemented by aspects of the wireless communications system 100 as described with reference to FIG. 1. For example, the wireless communications system 200 may include a UE 115-a, which may represent an example of a UE 115 as described with reference to FIG. 1. The UE 115-a may be in wireless communications with a network entity 105-a, which may represent an example of a network entity 105 or some other network node as described with reference to FIG. 1. The network entity 105-a may transmit or relay data or control signaling to the UE 115-a via one or more other access network transmission entities, which may be referred to as radio heads or TRPs 210.

The TRPs 210-a and 210-b may be included in or associated with the network entity 105-a. The network entity 105-a and the TRPs 210 may communicate with each other via one or more backhaul links 220, which may be examples of a backhaul communication link 120 as described with reference to FIG. 1. Although the TRPs 210-a and 210-b are illustrated as being connected with or in communication with a same network entity 105-a in FIG. 2, it is to be understood that the UE 115-a may communicate with any quantity of TRPs 210 that may be in communication with any quantity of different or same network entities 105 via any quantity of backhaul links 220, as described with reference to FIG. 1.

The UE 115-a may communicate with the TRPs 210 via uplink communication links 215 and downlink communication links 225. For example, the TRP 210-a and the TRP 210-b may transmit, to the UE 115-a, an RRC message 230, a DCI 235, reference signals 240, a physical downlink channel 245 (e.g., PDSCH, PDCCH), or any combination thereof, via the downlink communication links 225-a and 225-b, respectively. The UE 115-a may transmit one or more uplink signals, a UE capability message 250, or both to the TRP 210-a, the TRP 210-b, or both, via the uplink communication links 215-a and 215-b, respectively.

The UE 115-a and each of the TRPs 210-a and 210-b may communicate using a set of beams 255. For example, the UE 115-a may communicate using one or more beams of the set of beams 255-c. The UE 115-a may switch between beams based on communications from the TRP 210-a, the TRP 210-b, or both. The TRP 210-a may communicate using one or more beams of a set of beams 255-a and the TRP 210-b may communicate using one or more beams of a set of beams 255-b. Each TRP 210 may switch between beams based on communications from the UE 115-a.

The TRPs 210 may communicate with the UE 115-a using a spatial-division multiplexing (SDM) scheme, an FDM scheme, a TDM scheme, or a combination thereof. The TRPs 210 may coordinate a transmission of a physical downlink channel 245 (e.g., a PDSCH, a PDCCH, or both), an uplink channel (e.g., a physical uplink shared channel (PUSCH), a physical uplink control channel (PUCCH), or both). For example, an SDM scheme may involve the TRP 210-a and the TRP 210-b performing a joint transmission over a same resource (e.g., over a same set of resource elements and OFDM symbols) based on transmitting different layers, such as spatial layers, with different TCI states. Additionally, or alternatively, an FDM scheme may involve the TRP 210-a and the TRP 210-b performing the joint transmissions over different frequency resources and overlapping time resources, such as over different sets of resource elements but over a same set of OFDM symbols, based on transmitting different sets of frequency-domain resources (e.g., resource elements, resource blocks) with different TCI states.

In some examples of a TDM scheme, the TRP 210-a and the TRP 210-b may perform the joint transmissions over different time resources and overlapping frequency resources, such as over different sets of OFDM symbols and overlapping set of resource elements, based on transmitting different sets of time-domain resources (e.g., OFDM symbols, slots, or mini-slots) with different TCI states. In some aspects, the TRP 210-a and the TRP 210-b may perform downlink repetition. For example, the TRP 210-a may transmit a first instance of a downlink message at a first time and the TRP 210-b may transmit a repetition of the downlink message at a second time. Such repetition may occur for any quantity of downlink messages, which may include DCI 235, a physical downlink channel 245, or both.

In some aspects, the TRP 210-a and the TRP 210-b may perform joint transmissions to the UE 115-a using an SFN communication configuration, which may also be referred to as a single-frequency communication scheme. The SFN communication configuration may be a type of multi-TRP communication scheme in which multiple TRPs 210 may transmit a same data sequence on overlapping time and/or frequency resources. The SFN communications may be transmitted according to one or more types of communications schemes. For example, the TRP 210-a and the TRP 210-b may transmit a same transmission to the UE 115-a according to a multi-TRP communications configuration, such as an SDM scheme, an FDM scheme, a TDM scheme, or the like, where the downlink transmission is associated with one or more TCI states corresponding to the two or more TRPs 210. In other words, the downlink communication links 225-a and 225-b may be or may be part of an “SFNed” downlink communication link, which may be referred to as a combined SFN channel. A non-SFN communications configuration may correspond to communications in which two or more TRPs 210 refrain from utilizing the combined SFN channel and instead transmit the same or different data or control information to a UE 115 on non-overlapping time or frequency resources (e.g., in an asynchronous manner).

In the example of FIG. 2, a physical downlink channel 245 may be transmitted in accordance with SFN communications or in accordance with non-SFN communications. If the physical downlink channel 245 is transmitted using non-SFN communications, the TRP 210-a may transmit the physical downlink channel 245 to the UE 115-a via the downlink communication link 225-a or the TRP 210-b may transmit the physical downlink channel 245 to the UE 115-a via the downlink communication link 225-b, or both (e.g., single TRP (sTRP) communications). In some aspects, each TRP 210 may separately transmit a respective physical downlink channel 245 via a respective downlink communication link 225 using non-SFN communications. If the physical downlink channel 245 is transmitted using SFN communications, the TRP 210-a and the TRP 210-b may transmit the same physical downlink channel 245 to the UE 115-a using one or more TCI states and via a combined SFN channel.

In some cases, the network entity 105-a may transmit information to the UE 115-a to indicate one or more TCI states for the UE 115-a to use for receiving a physical downlink channel 245. For example, the network entity 105-a may transmit an RRC message 230 to the UE 115-a to configure multiple TCI states for use at the UE 115-a. The network entity 105-a may, in some examples, transmit a subsequent control message (e.g., a MAC-CE) that activates or indicates a subset of the configured TCI states for the UE 115-a, which may be referred to as a TCI activation MAC-CE. The subset of TCI states indicated by the MAC-CE may be mapped to respective codepoints. To schedule transmission and reception of a given physical downlink channel 245, the network entity 105-a may transmit DCI 235 that indicates (e.g., a transmission configuration indication field pointing to) a codepoint corresponding to a particular TCI state. The TCI state may correspond to one or more QCL relationships between the physical downlink channel 245 (e.g., antenna ports associated with the physical downlink channel 245) and a reference signal 240. The UE 115-a may use the indicated TCI state to assume that the physical downlink channel 245 is QCLed with one or more reference signals 240 associated with the indicated TCI state.

The UE 115-a and the network entity 105-a may, in some aspects, support a unified TCI framework, as described with reference to FIG. 1. For example, one or more codepoints indicated by the DCI 235 may include unified TCI states. The unified TCI states may include one or more joint TCI states that may be applied to multiple physical downlink channels 245 or uplink channels, one or more separate TCI states for each physical downlink channel 245 or uplink channel, or both. In some aspects, if a UE 115-a communicates with multiple TRPs 210, the DCI 235 may indicate a respective codepoint that indicates TCI states for each TRP 210. Additionally, or alternatively, the UE 115-a may receive separate DCI 235 to indicate TCI states for each TRP 210. In some other aspects, mapping between indicated TCI states and TRPs 210 may be based on a defined order or pattern.

In some cases, a TCI state may be associated with a TCI type (e.g., a unified TCI type). For example, a first unified TCI type may be a separate downlink common TCI type that indicates a common beam for one or more physical downlink channels 245 and/or reference signals 240, a second unified TCI type may be a separate uplink common TCI type that indicates a common beam for multiple uplink channels and/or reference signals, a third unified TCI type may be a joint TCI type that indicates a common beam for both physical downlink channels 245 and uplink channels and/or reference signals 240, a fourth unified TCI type may be a separate downlink single TCI type that indicates a beam for a single physical downlink channel 245 and/or reference signal 240, a fifth unified TCI type may be a separate uplink single TCI type that indicates a beam for a single uplink channel and/or reference signal, and a sixth unified TCI type may include SRI that indicates a beam for a single uplink channel and/or reference signal. In some examples, these various TCI types may be respective examples of one or more unified TCI types (e.g., TCI types associated with a unified TCI framework). In some cases, however, if the UE 115-a receives DCI 235 that indicates one or more unified TCI types, the UE 115-a may lack procedures for applying the unified TCI types for receiving SFNed signals from two or more TRPs 210. For example, there may not be defined techniques that indicate whether the UE 115-a is to apply each indicated TCI state for receiving one or more types of physical downlink channels 245 received in accordance with SFN communications.

Techniques described herein provide for improved coordination between devices and more reliable SFN communications by indicating SFN communication schemes for using unified TCI states to transmit and receive communications in accordance with the SFN communications. The network entity 105-a may indicate one or more SFN communication schemes for the UE 115-a via a first control message, which may represent an example of an RRC message 230 or some other type of control message. The network entity 105-a may transmit a control message, such as a MAC-CE (e.g., a TCI activation MAC-CE), or some other control message, to the UE 115-a to activate one or more TCI states for the UE 115-a. The network entity may transmit a second control message, such as the DCI 235, may indicate at least one TCI codepoint. The activated TCI states may correspond to a joint unified TCI type applicable to multiple types of physical downlink channels 245 and uplink channels, a separate unified TCI type applicable to one or more types of physical downlink channels 245, or both. If the UE 115-a is scheduled to receive an SFNed physical downlink channel 245, the UE 115-a may utilize the SFN communication scheme(s) indicated by the first control message to determine which TCI states to use for receipt of the SFNed physical downlink channel.

The DCI 235 may indicate a codepoint that points to one or more TCI states if the UE 115-a supports multi-TRP communications. For example, the UE 115-a may transmit a capability message 250 to the network entity 105-a to indicate a capability of the UE 115-a to support multi-TRP communications. In some aspects, the capability message 250 may indicate a dynamic SFN capability of the UE 115-a, which may indicate that the UE 115-a is capable of dynamically switching between sTRP communications and SFNed communications with multiple TRPs 210. If the UE 115-a supports multi-TRP or SFN communications, the codepoint indicated by the DCI 235 (e.g., a TCI field in DCI 1_1 or 1_2) may include a single TCI state, two TCI states, or more TCI states. In some examples, if the capability message 250 indicates that the UE 115-a is not capable of multi-TRP communications or SFN communications, the codepoint indicated by the DCI 235 may indicate a single TCI state.

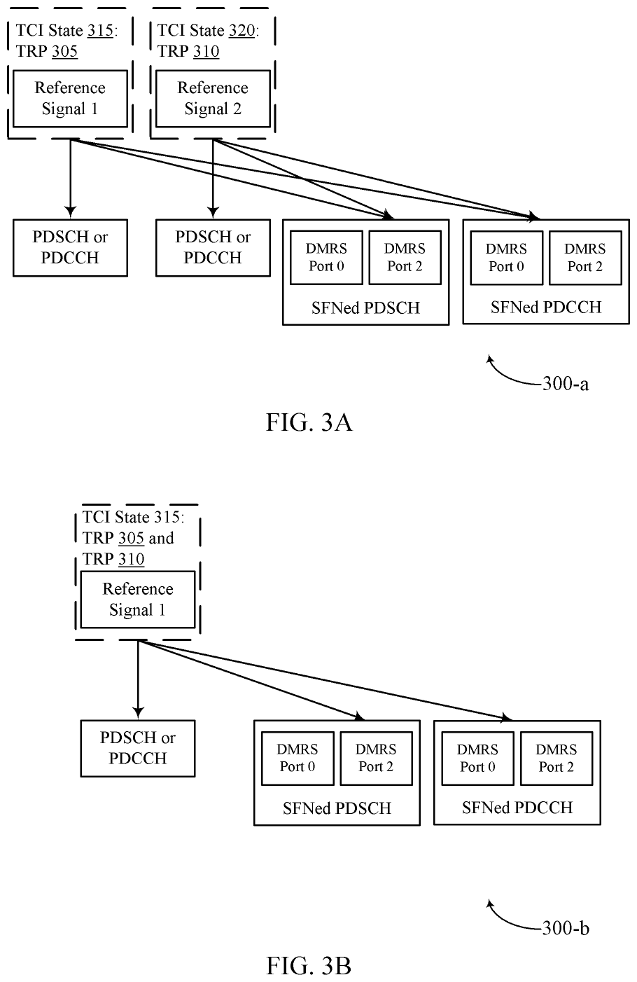

If the codepoint indicated by the DCI 235 includes a single TCI state, the UE 115-a may apply the single TCI state for receiving SFNed physical downlink channel 245, irrespective of which SFN communication scheme is configured via the RRC message 230. The UE 115-a may apply the single unified TCI state indicated via a DCI 235 (e.g., a TCI indication DCI) with or without downlink assignment. Application of a single TCI state is described in further detail elsewhere herein, including with reference to FIG. 3B.

If the codepoint indicated by the DCI 235 includes two or more unified TCI states, the UE 115-a may determine which TCI state(s) to apply for receipt of a given physical downlink channel 245 based on a type of the unified TCI states, based on the one or more SFN communication schemes indicated via the RRC message 230, or both. In some aspects, the DCI 235 may indicate two or more joint TCI states applicable to multiple types of physical downlink channels 245 (e.g., and uplink channels). In such cases, the RRC message 230 may include an SFN parameter that may indicate an SFN communication scheme from a set of multiple SFN communications schemes that is applicable to multiple types of physical downlink channels 245, such as a PDSCH and a PDCCH.

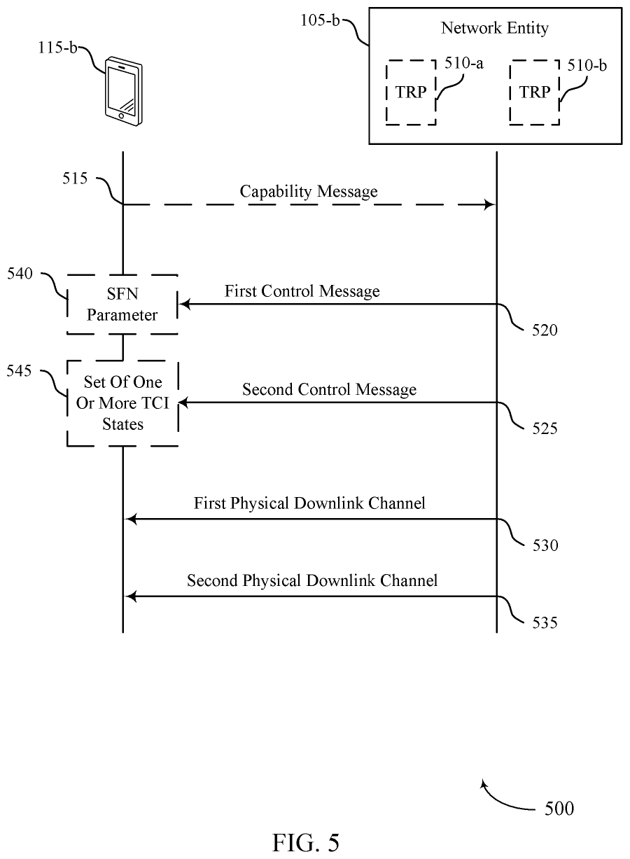

If the SFN parameter indicates a first SFN communication scheme, the UE 115-a may use each joint TCI state indicated via the DCI 235 to receive each type of SFNed physical downlink channel 245 from the TRP 210-a and the TRP 210-b. If the SFN parameter indicates a second SFN communication scheme, the UE 115-a may use a first set of QCL parameters associated with a first joint TCI state indicated via the DCI 235 and a second set of QCL parameters associated with a second joint TCI state indicated via the DCI 235 to receive each type of SFNed physical downlink channel 245 from the TRP 210-a and the TRP 210-b. In some aspects, the second set of QCL parameters may exclude one or more QCL parameters that may be included in the first set of QCL parameters. Such joint SFN communication schemes are described in further detail elsewhere herein, including with reference to FIGS. 3A and 5.

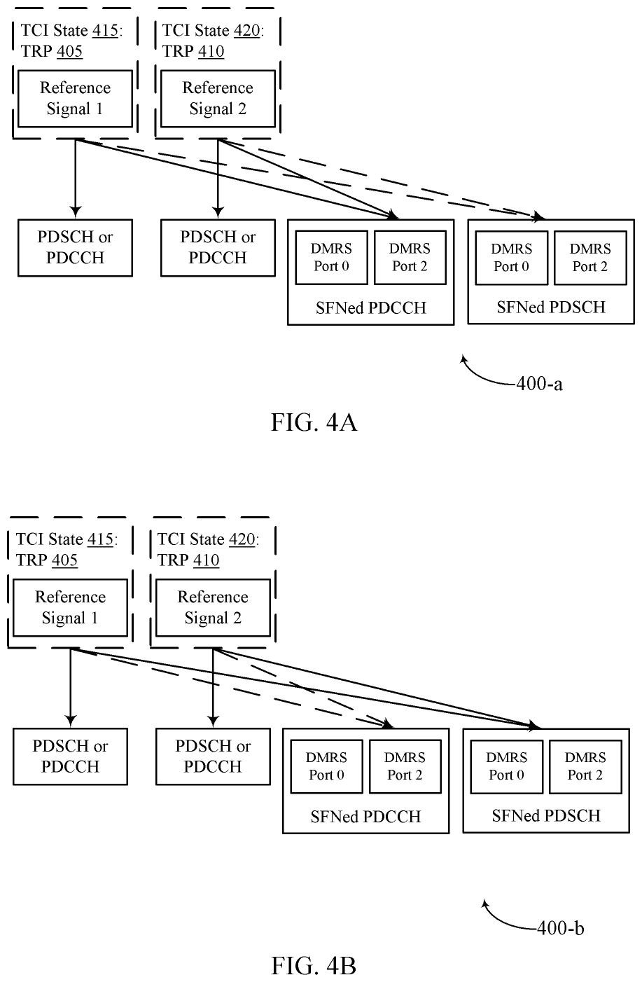

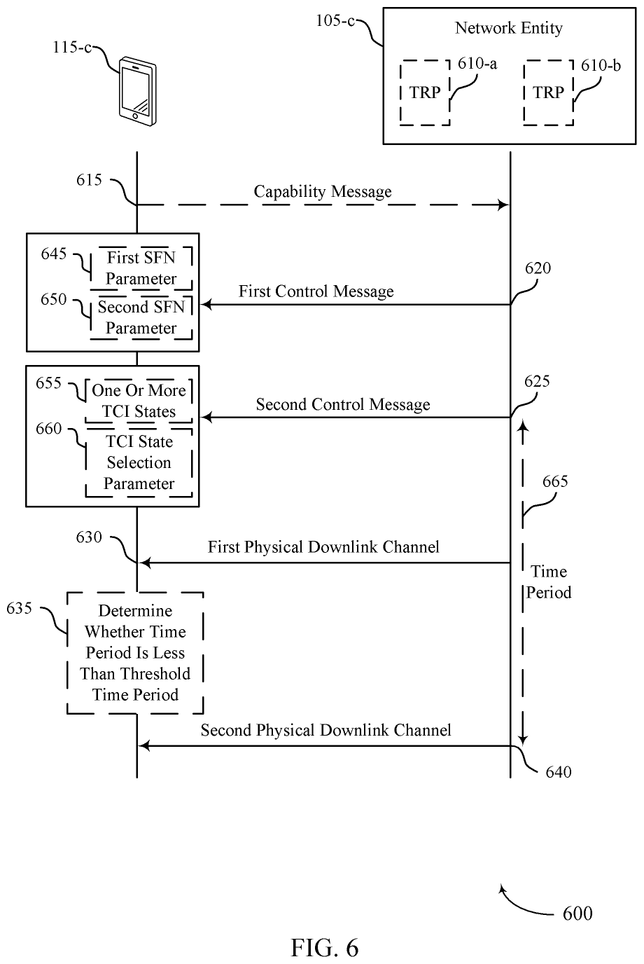

In some aspects, the codepoint indicated by the DCI 235 may correspond to two or more separate TCI states, and each TCI state may be applicable to a respective physical downlink channel 245 or uplink channel. In such cases, the RRC message 230 may include a first SFN parameter that may indicate a first SFN communication scheme applicable to a first type of physical downlink channel 245, a second SFN parameter that may indicate a second SFN communication scheme applicable to a second type of physical downlink channel 245, or both. The UE 115-a may determine which TCI state to apply for receiving each type of physical downlink channel 245 based on the first parameter, the second parameter, or both included in the RRC message, as described in further detail elsewhere herein, including with reference to FIGS. 4A, 4B, and 6.

The network entity 105-a may thereby configure the UE 115-a with one or more SFN communication schemes. The SFN communication schemes may indicate a set of rules, parameters, or guidelines for the UE 115-a to use to determine how to apply unified TCI states for receipt of physical downlink channels 245 transmitted from multiple TRPs 210 in accordance with the SFN communications. By utilizing the SFN communication schemes described herein, coordination between the UE 115-a and the multiple TRPs 210, as well as communication reliability and throughput, may improve.

FIGS. 3A and 3B illustrate examples of communication scheme diagrams 300-a and 300-b, respectively, that support unified TCI state indication for SFNs in accordance with one or more aspects of the present disclosure. In some examples, the communication scheme diagrams 300-a and 300-b may implement or be implemented by aspects of the wireless communications system 100 or the wireless communications system 200. For example, a TRP 305, a TRP 310, or both, which may be examples of TRPs 210 as described with reference to FIG. 2 (e.g., multi-TRPs), and one or more UEs 115 may employ one or more SFN schemes illustrated by the communication scheme diagrams 300-a and 300-b, as described with reference to FIGS. 1 and 2.

In the example of FIGS. 3A and 3B, a UE 115 may be configured with a joint configuration for applying unified TCI states across multiple channels, as described with reference to FIG. 2. In such cases, a network entity 105 may transmit a first control message to the UE 115 that includes a parameter (e.g., an sfnScheme parameter) indicative of an SFN communication scheme applicable to two or more physical downlink channels, such as the PDSCH and the PDCCH illustrated in FIGS. 3A and 3B, or some other types of physical downlink channels. The parameter may indicate a first SFN communication scheme (e.g., sfnSchemeA), a second SFN communication scheme (e.g., sfnSchemeB), or some other type of SFN communication scheme applicable to both a PDSCH and a PDCCH. The network entity 105 may transmit a second control message, such as DCI, that may indicate a TCI codepoint that corresponds to one or more TCI states, as described with reference to FIGS. 1 and 2. The UE 115 may determine how to apply the TCI states, which may include joint TCI states common to one or more downlink channels, for receipt of a PDSCH, a PDCCH, another downlink channel, or any combination thereof (e.g., UE-specific downlink channels) based on the configured SFN communication scheme.

The communication scheme diagram 300-a illustrates an SFN scheme when two or more TCI states are indicated via the DCI. For example, the TCI codepoint indicated by the DCI may indicate the TCI state 315 for a first TRP 305 and the TCI state 320 for a second TRP 310. The TRPs 305 and 310 may be associated with a same or different network entity 105, as described with referenced to FIG. 2. The TRP 305 and the TRP 310 may transmit two separate reference signals (e.g., a reference signal 1 and a reference signal 2, respectively). Each reference signal may correspond to a single-TRP PDSCH or PDCCH transmission and a corresponding TCI state of the TRP. Additionally, or alternatively, the reference signals may be associated with a joint “SFNed” PDSCH, a joint SFNed PDCCH, or both. That is, each of the reference signal 1 and the reference signal 2 may serve as a source reference signal for demodulating a PDCCH or a PDSCH that is transmitted in accordance with SFN communications.

As described herein, if the TCI codepoint indicated by the DCI includes two or more TCI states that are associated with the joint TCI state configuration type, the UE 115 may determine which TCI states to use for receiving an SFNed downlink channel based on the SFN communication scheme that is indicated via the first control message. In some aspects, if a first SFN communications scheme is configured via the first control message (e.g., the sfnScheme parameter is set to sfnSchemeA), the UE 115 may assume that the DMRS port(s) of any type of SFNed physical downlink channel may be QCLed with the downlink reference signals of each of the activated TCI states.

In the example of FIG. 3A, if the first SFN communication scheme is configured, the UE 115 may assume that the DMRS port(s) of the PDSCH are QCLed with the downlink reference signal 1 of the TCI state 315 and the downlink reference signal 2 of the TCI state 320, and the UE 115 may assume that the DMRS port(s) of the PDCCH are QCLed with the downlink reference signal 1 of the TCI state 315 and the downlink reference signal 2 of the TCI state 320. The UE 115 may receive the SFNed physical downlink channels accordingly.

If a second SFN communications scheme is configured via the first control message (e.g., the sfnScheme parameter is set to sfnSchemeB), the UE 115 may assume that the DMRS port(s) of any type of SFNed physical downlink channel may be QCLed with the downlink reference signals of each of the activated TCI states except for one or more QCL parameters associated with a subset of the activated TCI states. For example, each TCI state may be QCLed in terms of one or more parameters, such as a delay spread parameter, a delay shift parameter, a doppler spread parameter, a doppler shift parameter, an average power parameter, one or more other parameters, or any combination thereof. If two TCI states are included in the codepoint indicated by the DCI and the second SFN communication scheme is configured, the UE 115 may assume that the DMRS port(s) of the physical downlink channels are each QCLed with the first TCI state in terms of a first set of QCL parameters and that the DMRS port(s) of the physical downlink channels are each QCLed with the second TCI state in terms of a second set of QCL parameters, where the second set may exclude one or more parameters that are included in the first set. That is, the second set may be smaller than the first set or may be a subset of the first set. In some aspects, the second set may exclude a doppler shift parameter, a doppler spread parameter, or both.

In the example of FIG. 3A, if the second SFN communication scheme is configured, the UE 115 may assume that the DMRS port(s) of the PDSCH are QCLed with a first set of QCL parameters associated with the downlink reference signal 1 of the TCI state 315 and that the DMRS port(s) of the PDCCH are QCLed with the first set of QCL parameters associated with the downlink reference signal 1 of the TCI state 315. Additionally, the UE 115 may assume that the DMRS port(s) of the PDSCH are QCLed with a second set of QCL parameters associated with the downlink reference signal 2 of the TCI state 320 and that the DMRS port(s) of the PDCCH are QCLed with the second set of QCL parameters associated with the downlink reference signal 2 of the TCI state 320. The first set of QCL parameters may include a delay spread parameter, a delay shift parameter, a doppler spread parameter, a doppler shift parameter, or any combination thereof. The second set of parameters may exclude one or more of the QCL parameters.

Thus, in the example of the communications scheme diagram 300-a, each of the PDCCH and the PDSCH may be QCLed with (e.g., in terms of at least one QCL parameter) the TCI state 315 and the TCI state 320. In some aspects (e.g., transparent SFN), each DMRS port (e.g., one or more of the DMRS port 0, the DMRS port 2, or some other DMRS port) or data layer of the “SFNed” PDSCH and PDCCH may be associated with both the TCI state 315 and the TCI state 320. In other words, the TRP 305 and the TRP 310 may transmit reference signals (such as TRSs) in a TRP-specific or non-SFN manner while the associated DMRS (e.g., for demodulating the channel) and PDSCH or PDCCH from the TRPs are transmitted in an SFN manner. Additionally or alternatively (e.g., non-transparent SFN), each data layer of the joint PDSCH or PDCCH may be associated with both of the TCI state 315 and the TCI state 320 while each DMRS port of the joint PDSCH or PDCCH may be associated with either the TCI state 315 or the TCI state 320 (e.g., not both). For example, a DMRS port 0 of the joint PDSCH may be associated with the TCI state 315 (and not with the TCI state 320) and a DMRS port 2 of the joint PDSCH may be associated with the TCI state 320 (and not with the TCI state 315). The data layers of the joint PDSCH may be associated with both the TCI state 315 and the TCI state 320 through the DMRS ports. In other words, the TRP 305 and the TRP 310 may transmit reference signals (such as TRSs) and DMRSs in a TRP-specific or non-SFN manner while the associated PDSCH (e.g., data layers) from the TRPs is transmitted in an SFN manner. The communication scheme diagram 300-b illustrates an SFN scheme when a single TCI state 315 is included in the TCI codepoint indicated by the DCI. Here, the UE 115 may be configured with the parameter (e.g., the sfnScheme parameter) set to either the first SFN communication scheme (e.g., sfnSchemeA) or the second SFN communication scheme (e.g., sfnSchemeB). In such cases, the UE 115 may assume that the DMRS port(s) of the PDCCH and the PDSCH are QCLed with the downlink reference signal(s) (e.g., reference signal 1 and/or one or more other reference signals) of the TCI state 315. In such cases, each DMRS port (e.g., one or more of the DMRS port 0, the DMRS port 2, or some other DMRS port) or data layer of the “SFNed” PDSCH and PDCCH may be associated with or QCLed with the TCI state 315.

FIGS. 4A and 4B illustrate examples of communication scheme diagrams 400-a and 400-b, respectively, that support unified TCI state indication for SFNs in accordance with one or more aspects of the present disclosure. In some examples, the communication scheme diagrams 400-a and 400-b may implement or be implemented by aspects of the wireless communications system 100 or the wireless communications system 200. For example, a TRP 405, a TRP 410, or both, which may be examples of TRPs 210 as described with reference to FIG. 2 (e.g., multi-TRPs), and one or more UEs 115 may employ one or more SFN schemes illustrated by the communication scheme diagrams 400-a and 400-b, as described with reference to FIGS. 1 and 2.

In the example of FIGS. 4A and 4B, the UE 115 may be configured with a separate configuration for applying unified TCI states to respective channels, as described with reference to FIG. 2. In such cases, the network entity 105 may transmit a first control message to the UE 115 that includes one or both of a first parameter (e.g., sfnSchemepdcch) indicative of an SFN communication scheme applicable to a first physical downlink channel, such as the PDCCH illustrated in FIGS. 4A and 4B, and a second parameter (e.g., sfnSchemepdsch) indicative of an SFN communication scheme applicable to a second physical downlink channel, such as the PDSCH illustrated in FIGS. 4A and 4B.

The network entity 105 may transmit a control message, such as a MAC-CE, that may activate a set of TCI states, as described with reference to FIGS. 1-3. In some examples, the network entity 105 may transmit a second control message (e.g., DCI) that includes a quantity of bits within a TCI field indicating a TCI codepoint. The TCI codepoint may correspond to one or more TCI states. In some examples, the TCI state(s) indicated by the DCI may include a separate TCI state for each respective downlink channel. The UE 115 may determine how to apply the indicated TCI state(s) for receipt of a PDCCH, a PDSCH, one or more other types of downlink channels, or any combination thereof, transmitted by two or more TRPs in accordance with SFN communications and based on the SFN communication scheme(s) that are configured by the first control message.

The communication scheme diagrams 400-a and 400-b illustrate example SFN schemes when two or more TCI states are indicated via the DCI. For example, the TCI codepoint indicated by the DCI may correspond to the TCI state 415 for a first TRP 405 and the TCI state 420 for a second TRP 410. The TRPs 405 and 410 may be associated with a same or different network entity 105, as described with referenced to FIGS. 2 and 3. The TRP 405 and the TRP 410 may transmit one or more separate reference signals (e.g., a reference signal 1 and a reference signal 2, respectively). Each reference signal may correspond to a single-TRP PDSCH or PDCCH transmission and a corresponding TCI state of the TRP. Additionally, or alternatively, the reference signals may be associated with a joint “SFNed” PDSCH, a joint SFNed PDCCH, or both. That is, each of the reference signal 1 and the reference signal 2 may serve as a source reference signal for demodulating a PDCCH or a PDSCH that is transmitted in accordance with SFN communications. If a single TCI state is indicated via the DCI, the UE 115 may assume that the DMRS port(s) of the PDCCH and the PDSCH are QCLed with the downlink reference signals of the indicated TCI state, as described with reference to FIG. 3B.

In some aspects, the first control message (e.g., an RRC message) may indicate both the first and second parameters. That is, the first control message may separately configure an SFN communication scheme for the PDSCH (e.g., sfnSchemepdsch) and an SFN communication scheme for the PDCCH (e.g., sfnSchemepdcch). In such cases, the UE 115 may assume that the DMRS port(s) of the PDCCH are QCLed with the downlink reference signals of the two TCI states and that the DMRS port(s) of the PDSCH are QCLed with the downlink reference signals of the two TCI states, as illustrated and described with reference to FIG. 3A. In some other aspects, the first control message may indicate one of the first and second parameters and may exclude the other parameter.

The communication scheme diagram 400-a illustrates an example SFN scheme when a first parameter for PDCCH is included and a second parameter for PDSCH is excluded from the first control message (e.g., the first parameter may be configured and the second parameter may not be configured). In such cases, the UE 115 may assume that the DMRS port(s) of the PDCCH may be QCLed with the downlink reference signals of each of the activated TCI states and the DMRS port(s) of the PDSCH may be QCLed with the downlink reference signals of a subset of the activated TCI states. For example, the DMRS ports of the PDCCH in FIG. 4A may be QCLed with the downlink reference signal 1 of the TCI state 315 and the downlink reference signal 2 of the TCI state 320. The DMRS ports of the PDSCH in FIG. 4A may be QCLed with either the downlink reference signal 1 of the TCI state 315 or the downlink reference signal 2 of the TCI state 320. In some aspects, selection of which TCI state to use may be up to UE implementation, may be based on a pre-configuration, may be based on a pre-defined rule (e.g., the TCI state 320 may be selected based on value of a TCI ID associated with the TCI state 320 being a lowest TCI ID value, or some other rule), may be based on a configured default TCI state, or any combination thereof.

Additionally, or alternatively, the network entity may transmit a TCI state selection parameter to the UE 115 to indicate one or more TCI states for the UE 115 to use to receive the PDSCH. The TCI state selection parameter may be transmitted via the second control message (e.g., scheduling DCI), or some other control signaling. The TCI state selection parameter may indicate one or more TCI states. In the example of FIG. 4A, two TCI states may be activated, and the TCI state selection parameter may indicate the TCI state 315, the TCI state 320, or both the TCI state 315 and the TCI state 320 for PDSCH.

If the TCI state selection parameter is included in the DCI that schedules the PDSCH, the UE 115 may assume that the DMRS ports of the PDSCH are QCLed with the downlink reference signals of the selected TCI states indicated by the TCI state selection parameter. The UE 115 may use the selected TCI states if a time offset or time period between reception of the scheduling DCI and reception of the corresponding PDSCH is greater than or equal to a threshold time period (e.g., timeDurationForQCL). If the time period is less than the threshold time period, the UE 115 may use a default TCI scheme for receipt of the PDSCH. In some examples, the UE 115 may determine a default TCI state to use for receipt of a PDSCH based on a rule, where the rule may specify that the default TCI state may be a TCI state that is associated with a TCI state ID having a lowest value of each TCI state ID of the other TCI states indicated in the DCI.

In the example of FIG. 4A, if the TCI state selection parameter indicates the TCI state 315, the UE 115 may assume that the DMRS ports of the PDSCH are QCLed with the reference signal 1 of the TCI state 315, and the UE 115 may receive the PDSCH accordingly. If the TCI state selection parameter indicates the TCI state 315 and the TCI state 320, the UE 115 may assume that the DMRS ports of the PDSCH are QCLed with the reference signal 1 of the TCI state 315 and the reference signal 2 of the TCI state 320, and the UE 115 may receive the PDSCH accordingly. If, however, the time period between receipt of the DCI and receipt of the PDSCH is less than the threshold time period, the UE 115 may assume a default TCI scheme.

The communication scheme diagram 400-b illustrates an example SFN scheme when a first parameter for PDCCH is excluded from the first control message and a second parameter for PDSCH is included in the first control message (e.g., the second parameter may be configured and the first parameter may not be configured). In such cases, the UE 115 may assume that the DMRS port(s) of the PDSCH may be QCLed with the downlink reference signals of each of the activated TCI states and the DMRS port(s) of the PDCCH may be QCLed with the downlink reference signals of a subset of the activated TCI states. For example, the DMRS ports of the PDSCH in FIG. 4B may be QCLed with the downlink reference signal 1 of the TCI state 315 and the downlink reference signal 2 of the TCI state 320. The DMRS ports of the PDCCH in FIG. 4B may be QCLed with either the downlink reference signal 1 of the TCI state 315 or the downlink reference signal 2 of the TCI state 320. In some aspects, selection of which TCI state to use may be up to UE implementation, may be random, may be based on a defined rule, may be based on a configured default TCI state, or any combination thereof.

For example, if the UE 115 is configured (e.g., via an RRC configuration) with a default TCI scheme corresponding to the TCI state 315, the UE 115 may assume that the DMRS ports of the PDCCH are QCLed with the downlink reference signal 1 of the TCI state 315, and the UE 115 may receive the PDCCH accordingly.

FIG. 5 illustrates an example of a process flow 500 in a system that supports unified TCI state indication for SFNs in accordance with one or more aspects of the present disclosure. The process flow 500 may implement or be implemented by aspects of the wireless communications systems 100 and 200 or the communication scheme diagrams 300 and 400, as described with reference to FIGS. 1-4. For example, the process flow 500 illustrates communications between a UE 115-b and a network entity 105-b, which may represent aspects of corresponding devices as described with reference to FIGS. 1-4. The network entity 105-b may include a TRP 510-a and a TRP 510-b (e.g., among one or more other TRPs 510). In some aspects, the network entity 105-b may configure an SFN communication scheme for the UE 115-b to use for receipt of first and second physical downlink channels transmitted from the TRP 510-a and the TRP 510-b in accordance with SFN communications.

In the following description of the process flow 500, the operations between the UE 115-b and the network entity 105-b may be performed in different orders or at different times. Some operations may also be left out of the process flow 500, or other operations may be added. Although the UE 115-b and the network entity 105-b are shown performing the operations of the process flow 500, some aspects of some operations may also be performed by one or more other wireless devices.

At 515, in some aspects, the UE 115-b may transmit a capability message to the network entity 105-b. The capability message may indicate a capability of the UE 115-b to support SFN communications with multiple TRPs 510 or a capability of the UE 115-b to support single TRP communications, as described with reference to FIG. 2. In the example of FIG. 5, the capability message may indicate the capability of the UE 115-b to support the SFN communications with the TRPs 510-a and 510-b. In some aspects, the UE 115-b may switch between SFN communications and single TRP communications (e.g., a “dynamicSFN” capability).

At 520, the network entity 105-b may transmit a first control message to the UE 115-b. The first control message may include a parameter, such as the SFN parameter 540, that indicates an SFN communication scheme applicable to both a first physical downlink channel and a second physical downlink channel. The first control message may be an RRC message, a MAC-CE, or some other type of control message, as described with reference to FIGS. 1-4. The SFN parameter 540 may indicate an SFN communication scheme from a set of multiple potential SFN communication schemes. In some aspects, the SFN parameter 540 may indicate a first SFN communication scheme (e.g., sfnSchemeA) or a second SFN communication scheme (e.g., sfnSchemeB), as described in further detail elsewhere herein, including with reference to FIGS. 3A and 3B.

At 525, the network entity 105-b may transmit a second control message to the UE 115-b. The second control message may indicate a set of one or more TCI states 545 from multiple configured TCI states. A codepoint indicated by the second control message (e.g., DCI) may point to the set of one or more TCI states 545. In some aspects, a quantity of TCI states that are activated by the second control message may be based on the capability message transmitted at 515. For example, if the capability message indicates a capability of the UE 115-b to support SFN communications with multiple TRPs 510, the second control message may indicate a codepoint that includes one or more TCI states based on the capability message. If the capability message indicates a capability of the UE 115-b to support sTRP communications and not multi-TRP communications, the second control message may indicate a codepoint that includes a single TCI state.

At 530, the network entity 105-b may transmit the first physical downlink channel to the UE 115-b. At 535, the network entity 105-b may transmit the second physical downlink channel to the UE 115-b. Each of the first and second physical downlink channels may be transmitted by the TRP 510-a and the TRP 510-b in accordance with SFN communications, as described with reference to FIGS. 1-4. It is to be understood that the first and second physical downlink channels may be received simultaneously or in at least partially overlapping time periods. Additionally, or alternatively, the first and second physical downlink channels may be received at separate times, and may be received in any order. The UE 115-b may apply the unified TCI states indicated by the codepoint in the DCI to receipt of the first and second physical downlink channels (e.g., UE-specific PDSCH and PDCCHs) irrespective of whether a downlink assignment is indicated in the DCI.

The network entity 105-b and the UE 115-b may select a subset of one or more TCI states from the set of one or more TCI states 545 to use for transmission and reception, respectively, of the first and second physical downlink channels based on the SFN communication scheme indicated by the SFN parameter 540. For example, as described with reference to FIG. 3A, if a codepoint indicated by the second control message includes two or more TCI states, and the SFN parameter 540 indicates a first SFN communication scheme, the UE 115-b may receive, and the network entity 105-b may transmit, the first and second physical downlink channels using each TCI state of the set of one or more TCI states 545 indicated by the second control message. That is, the subset may include all of the set of one or more TCI states 545. Alternatively, if a codepoint indicated by the second control message includes two or more TCI states, and the SFN parameter 540 indicates a second SFN communication scheme, the UE 115-b may receive, and the network entity 105-b may transmit, the first and second physical downlink channels using a first set of QCL parameters associated with a first TCI state of the set of one or more TCI states 545 and a second set of one or more QCL parameters associated with a second TCI state of the set of one or more TCI states 545. The second set of QCL parameters may exclude one or more QCL parameters that may be included in the first set, as described with reference to FIG. 3A.

As described with reference to FIG. 3B, if a codepoint indicated by the second control message includes a single TCI state (e.g., the set of one or more TCI states 545 includes one TCI state), the UE 115-b may receive, and the network entity 105-b may transmit, both the first and second physical downlink channels using the single TCI state. For example, the UE 115-b may assume that the DMRS ports of the first and second physical downlink channels are QCLed with downlink reference signals associated with the single TCI state. The network entity 105-b may thereby configure the UE 115-b with an SFN communication scheme for using joint unified TCI states to receive physical downlink channels from two or more TRPs 510 in accordance with SFN communications.

FIG. 6 illustrates an example of a process flow 600 in a system that supports unified TCI state indication for SFNs in accordance with one or more aspects of the present disclosure. The process flow 600 may implement or be implemented by aspects of the wireless communications systems 100 and 200 or the communication scheme diagrams 300 and 400, as described with reference to FIGS. 1-4. For example, the process flow 600 illustrates communications between a UE 115-c and a network entity 105-c, which may represent aspects of corresponding devices as described with reference to FIGS. 1-5. The network entity 105-c may include a TRP 610-a and a TRP 610-b (e.g., among one or more other TRPs 610). In some aspects, the network entity 105-c may configure an SFN communication scheme for the UE 115-c to use for receipt of first and second physical downlink channels transmitted from the TRP 610-a and the TRP 610-b in accordance with SFN communications.

In the following description of the process flow 600, the operations between the UE 115-c and the network entity 105-c may be performed in different orders or at different times. Some operations may also be left out of the process flow 600, or other operations may be added. Although the UE 115-c and the network entity 105-c are shown performing the operations of the process flow 600, some aspects of some operations may also be performed by one or more other wireless devices.

At 615, in some aspects, the UE 115-c may transmit a capability message to the network entity 105-c. The capability message may indicate a capability of the UE 115-c to support SFN communications with multiple TRPs 610 or a capability of the UE 115-c to support single TRP communications, as described with reference to FIG. 2. In the example of FIG. 6, the capability message may indicate the capability of the UE 115-c to support the SFN communications with the TRPs 610-a and 610-b. In some aspects, the UE 115-c may switch between SFN communications and single TRP communications (e.g., a “dynamicSFN” capability).

At 620, the network entity 105-c may transmit a first control message to the UE 115-c. The first control message may indicate a first SFN parameter 645 associated with a first SFN communication scheme applicable to a first physical downlink channel or a second SFN parameter 650 associated with a second SFN communication scheme applicable to a second physical downlink channel, or both. The first control message may be an RRC message, a MAC-CE, or some other type of control message, as described with reference to FIGS. 1-5. In some aspects, the first SFN communication scheme may be applicable to a PDCCH (e.g., sfnSchemepdcch) and the second SFN communication scheme may be applicable to a PDSCH (e.g., sfnSchemepdsch), or vice versa, as described in further detail with reference to FIGS. 4A and 4B.

At 625, the network entity 105-c may transmit a second control message to the UE 115-c. The second control message may indicate one or more TCI states 655 from a set of multiple TCI states. In some aspects, a codepoint in the second control message (e.g., DCI) may point to the one or more TCI states 655. A quantity of TCI states that are indicated by the second control message may be based on the capability message transmitted at 615. For example, if the capability message indicates a capability of the UE 115-c to support SFN communications with multiple TRPs 610, the second control message may indicate a codepoint that includes one or more TCI states based on the capability message. If the capability message indicates a capability of the UE 115-c to support single TRP communications and not multi-TRP communications, the second control message may indicate a codepoint that includes a single TCI state.

In some aspects, the second control message may indicate a TCI state selection parameter 660. The TCI state selection parameter may indicate a single TCI state, two TCI states, or more TCI states of the one or more TCI states 655 to be applied for receipt of the second physical downlink channel (e.g., a PDSCH), as described in further detail with reference to FIG. 4A. The TCI state selection parameter 660 may, in some aspects, be transmitted via the second control message, which may be a scheduling DCI for the second physical downlink channel.

At 630, the network entity 105-c may transmit the first physical downlink channel to the UE 115-c. At 640, the network entity 105-c may transmit the second physical downlink channel to the UE 115-c. Each of the first and second physical downlink channels may be transmitted by the TRP 610-a and the TRP 610-b in accordance with SFN communications, as described with reference to FIGS. 1-5. It is to be understood that the first and second physical downlink channels may be received simultaneously or in at least partially overlapping time periods. Additionally, or alternatively, the first and second physical downlink channels may be received at separate times, and in any order. The network entity 105-c and the UE 115-c may use at least one of the one or more TCI states 655 to transmit and receive, respectively, the first and second physical downlink channels. The at least one TCI state may be selected by the network entity 105-c and the UE 115-c from the one or more TCI states 655 based on the first SFN communication scheme, the second SFN communication scheme, or both indicated by the first SFN parameter 645 and the second SFN parameter 650, respectively.

As described with reference to FIGS. 4A and 4B, if the codepoint indicated by the second control message includes two or more TCI states, and the first control message includes one of the first SFN parameter 645 or the second SFN parameter 650, but not both, the UE 115-c may receive, and the network entity 105-c may transmit, one of the first and second physical downlink channels that corresponds to the indicated SFN parameter using each TCI state of the one or more TCI states 655 and the other physical downlink channel using a subset of the one or more TCI states 655 indicated by the second control message.

For example, if the first control message includes the first SFN parameter 645 and excludes the second SFN parameter 650, the UE 115-c may receive the first physical downlink channel using each of the one or more TCI states 655 in accordance with the first SFN communication scheme applicable to the first physical downlink channel, and the UE 115-c may receive the second physical downlink channel using a subset of the one or more TCI states 655. The subset of TCI states may be configured (e.g., via RRC signaling) as a default subset, may be selected randomly, or may be indicated to the UE 115-c.

Alternatively, if the codepoint indicated by the second control message includes two or more TCI states, and the first control message includes both the first SFN parameter 645 and the second SFN parameter 650, the UE 115-c may receive, and the network entity 105-c may transmit, the first and second physical downlink channels using each TCI state of the one or more TCI states 655 indicated by the second control message, as described with reference to FIG. 3A.

In some aspects, if the second control message includes the TCI state selection parameter 660, the UE 115-c may receive the second physical downlink control channel using TCI states that are indicated by the TCI state selection parameter, regardless of whether both SFN parameters are included in the first control message. In such cases, the UE 115-c may determine whether to use the selected TCI states based on a time period 665. For example, at 635, in some aspects, the UE 115-c may determine whether the time period 665 between a first time at which the second control message is received by the UE 115-c and a current time is greater than or equal to a threshold time period. The current time may, in some aspects, correspond to a time that is the same as, or just before, receipt of the second physical downlink channel by the UE 115-c. In some aspects, the UE 115-c may receive a third control message (e.g., RRC, MAC-CE, or some other control information) that indicates the threshold time period. Additionally, or alternatively, the threshold time period may be configured at the UE 115-c.

If the time period 665 is greater than or equal to the threshold time period, the UE 115-c may have sufficient time to process the TCI state selection parameter 660 indicated via the second control message, and the UE 115-c may receive the second physical downlink channel using the TCI state(s) indicate by the TCI state selection parameter 660. If the time period 665 is less than the threshold time period, the UE 115-c may refrain from using the TCI state(s) indicated by the TCI state selection parameter 660 to receive the second physical downlink channel. Instead, the UE 115-c may use a default set of one or more TCI states, which may be configured for the UE 115-c (e.g., via RRC signaling).

As described with reference to FIG. 3B, if a codepoint indicated by the second control message includes a single TCI state (e.g., the one or more TCI states 655 includes one TCI state), the UE 115-c may receive, and the network entity 105-c may transmit, both the first and second physical downlink channels using the single TCI state. For example, the UE 115-c may assume that the DMRS ports of the first and second physical downlink channels are QCLed with downlink reference signals associated with the single TCI state. The network entity 105-c may thereby configure the UE 115-c with a respective SFN communication scheme for each type of physical downlink channel, such that the UE 115-c may use separate TCI states to receive downlink channels in accordance with SFN communications.

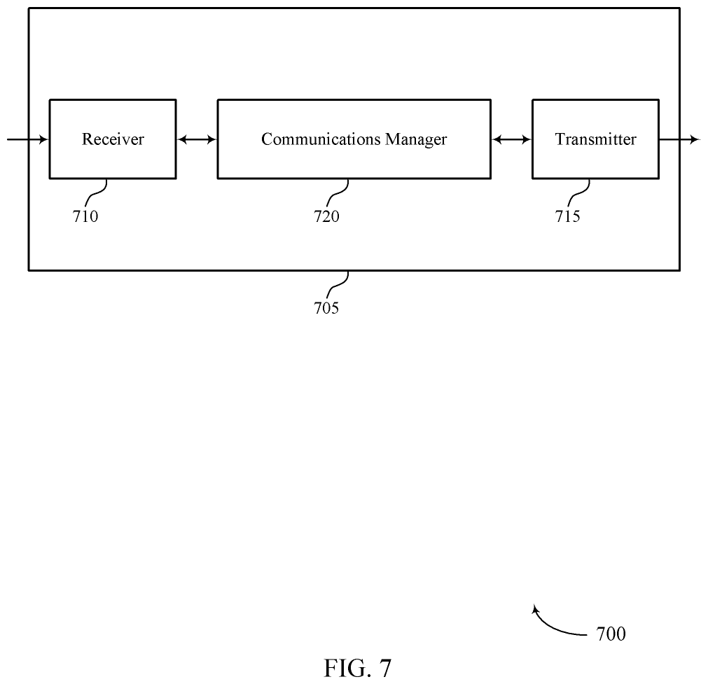

FIG. 7 shows a block diagram 700 of a device 705 that supports unified TCI state indication for SFNs in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to unified TCI state indication for SFNs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to unified TCI state indication for SFNs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of unified TCI state indication for SFNs as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving a first control message including a parameter that indicates an SFN communication scheme applicable to both a first physical downlink channel and a second physical downlink channel. The communications manager 720 may be configured as or otherwise support a means for receiving a second control message indicating a set of one or more TCI states from a set of multiple TCI states. The communications manager 720 may be configured as or otherwise support a means for receiving the first physical downlink channel and the second physical downlink channel using a subset of one or more TCI states, the subset of one or more TCI states selected from the set of one or more TCI states based on the SFN communication scheme indicated by the parameter.

Additionally, or alternatively, the communications manager 720 may support wireless communication at a UE in accordance with examples as disclosed herein. For example, the communications manager 720 may be configured as or otherwise support a means for receiving a first control message indicating a first parameter associated with a first SFN communication scheme applicable to a first physical downlink channel, or a second parameter associated with a second SFN communication scheme applicable to a second physical downlink channel, or both. The communications manager 720 may be configured as or otherwise support a means for receiving a second control message that indicates one or more TCI states from a set of TCI states. The communications manager 720 may be configured as or otherwise support a means for receiving each of the first physical downlink channel and the second physical downlink channel using at least one TCI state of the one or more TCI states based on the first SFN communication scheme indicated by the first parameter, the second SFN communication scheme indicated by the second parameter, or both.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, and more efficient utilization of communication resources. For example, the device 705 (e.g., a UE) may receive a control message that includes one or more parameters that indicate SFN communication schemes for the device 705. The parameters may indicate, to the processor of the device 705, which TCI states may be applied for receipt of a given physical downlink channel that is transmitted from two or more TRPs in accordance with SFN communications. By utilizing the parameters, the processor may refrain from arbitrarily or randomly assuming QCL relationships based on activated TCI states, such that the processor may support utilization of unified TCI states for SFNed downlink communications, which may reduce processing and power consumption. By supporting SFN communications, the processor may improve reliability and throughput of communications.

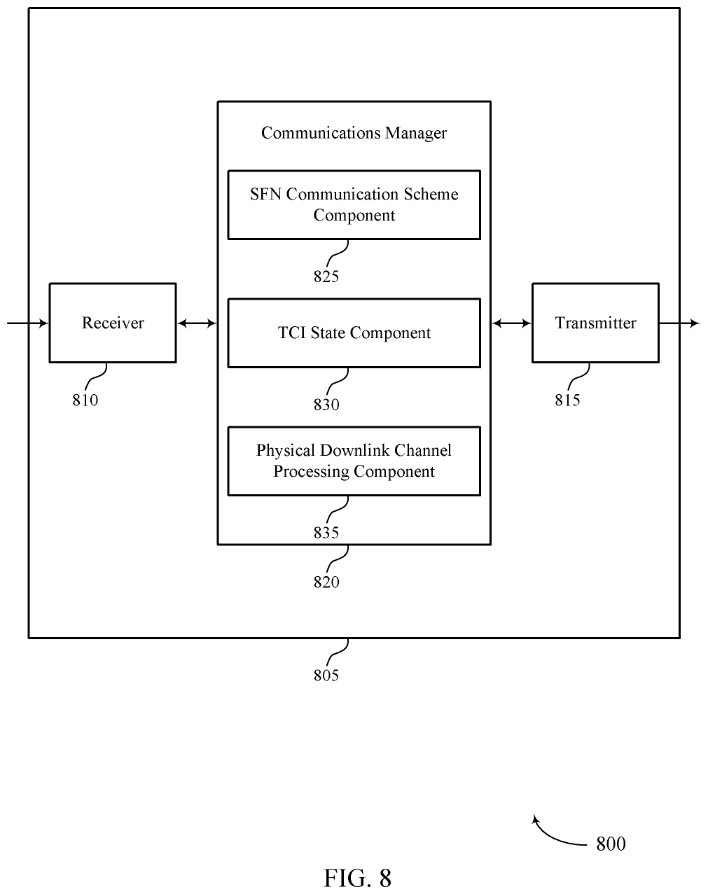

FIG. 8 shows a block diagram 800 of a device 805 that supports unified TCI state indication for SFNs in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to unified TCI state indication for SFNs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to unified TCI state indication for SFNs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of unified TCI state indication for SFNs as described herein. For example, the communications manager 820 may include an SFN communication scheme component 825, a TCI state component 830, a physical downlink channel processing component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The SFN communication scheme component 825 may be configured as or otherwise support a means for receiving a first control message including a parameter that indicates an SFN communication scheme applicable to both a first physical downlink channel and a second physical downlink channel. The TCI state component 830 may be configured as or otherwise support a means for receiving a second control message indicating a set of one or more TCI states from a set of multiple TCI states. The physical downlink channel processing component 835 may be configured as or otherwise support a means for receiving the first physical downlink channel and the second physical downlink channel using a subset of one or more TCI states, the subset of one or more TCI states selected from the set of one or more TCI states based on the SFN communication scheme indicated by the parameter.

Additionally, or alternatively, the communications manager 820 may support wireless communication at a UE in accordance with examples as disclosed herein. The SFN communication scheme component 825 may be configured as or otherwise support a means for receiving a first control message indicating a first parameter associated with a first SFN communication scheme applicable to a first physical downlink channel, or a second parameter associated with a second SFN communication scheme applicable to a second physical downlink channel, or both. The TCI state component 830 may be configured as or otherwise support a means for receiving a second control message that indicates one or more TCI states from a set of TCI states. The physical downlink channel processing component 835 may be configured as or otherwise support a means for receiving each of the first physical downlink channel and the second physical downlink channel using at least one TCI state of the one or more TCI states based on the first SFN communication scheme indicated by the first parameter, the second SFN communication scheme indicated by the second parameter, or both.

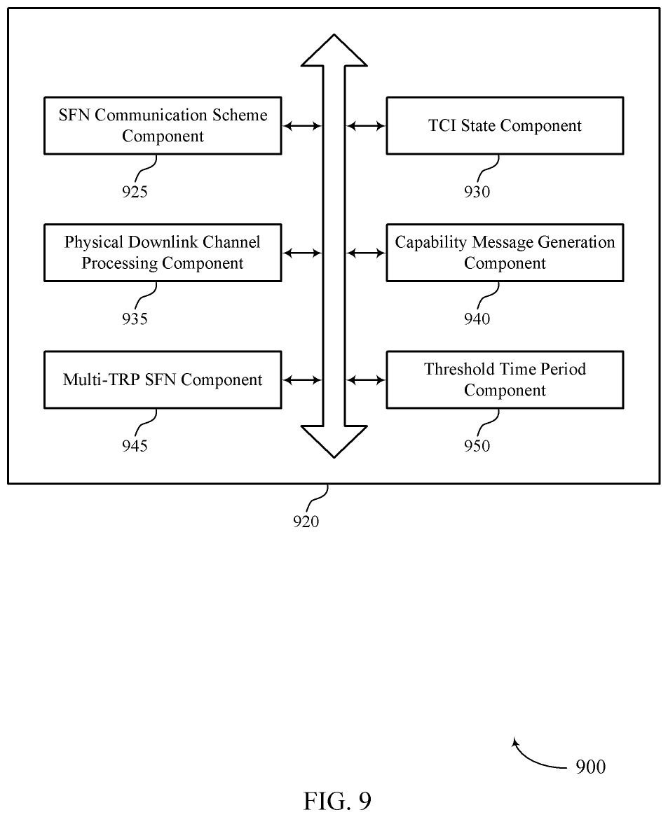

FIG. 9 shows a block diagram 900 of a communications manager 920 that supports unified TCI state indication for SFNs in accordance with one or more aspects of the present disclosure. The communications manager 920 may be an example of aspects of a communications manager 720, a communications manager 820, or both, as described herein. The communications manager 920, or various components thereof, may be an example of means for performing various aspects of unified TCI state indication for SFNs as described herein. For example, the communications manager 920 may include an SFN communication scheme component 925, a TCI state component 930, a physical downlink channel processing component 935, a capability message generation component 940, a multi-TRP SFN component 945, a threshold time period component 950, or any combination thereof. Each of these components may communicate, directly or indirectly, with one another (e.g., via one or more buses).

The communications manager 920 may support wireless communication at a UE in accordance with examples as disclosed herein. The SFN communication scheme component 925 may be configured as or otherwise support a means for receiving a first control message including a parameter that indicates an SFN communication scheme applicable to both a first physical downlink channel and a second physical downlink channel. The TCI state component 930 may be configured as or otherwise support a means for receiving a second control message indicating a set of one or more TCI states from a set of multiple TCI states. The physical downlink channel processing component 935 may be configured as or otherwise support a means for receiving the first physical downlink channel and the second physical downlink channel using a subset of one or more TCI states, the subset of one or more TCI states selected from the set of one or more TCI states based on the SFN communication scheme indicated by the parameter.

In some examples, the SFN communication scheme may correspond to a first SFN communication scheme of a set of multiple SFN communications schemes, and to support receiving the first physical downlink channel and the second physical downlink channel, the physical downlink channel processing component 935 may be configured as or otherwise support a means for receiving both the first physical downlink channel and the second physical downlink channel using each TCI state of the set of one or more TCI states indicated by the second control message based on the first SFN communication scheme. In some examples, a codepoint indicated by the second control message may include two TCI states from the set of multiple TCI states.

In some examples, the SFN communication scheme may correspond to a second SFN communication scheme of a set of multiple SFN communications schemes, and to support receiving the first physical downlink channel and the second physical downlink channel, the physical downlink channel processing component 935 may be configured as or otherwise support a means for receiving both the first physical downlink channel and the second physical downlink channel using a first set of QCL parameters associated with a first TCI state of the set of one or more TCI states and a second set of one or more QCL parameters associated with a second TCI state of the set of one or more TCI states based on the second SFN communication scheme, where the second set of one or more quasi co-location parameters excludes one or more QCL parameters.

In some examples, the first set of QCL parameters includes a doppler shift parameter, a doppler spread parameter, a delay shift parameter, a delay spread parameter, or any combination thereof. In some examples, the second set of one or more QCL parameters excludes one or more parameters of the first set of QCL parameters. In some examples, a codepoint indicated by the second control message may include two TCI states from the set of multiple TCI states.

In some examples, to support receiving the first physical downlink channel and the second physical downlink channel, the physical downlink channel processing component 935 may be configured as or otherwise support a means for receiving both the first physical downlink channel and the second physical downlink channel using a single TCI state based on the second control message indicating the single TCI state.

In some examples, the capability message generation component 940 may be configured as or otherwise support a means for transmitting a capability message indicating a capability of the UE to support SFN communications with multiple TRPs, where the second control message indicates a codepoint that includes one or more TCI states from the set of multiple TCI states based on the capability message.

In some examples, to support receiving the first physical downlink channel and the second physical downlink channel, the multi-TRP SFN component 945 may be configured as or otherwise support a means for receiving both the first physical downlink channel and the second physical downlink channel from two or more TRPs in accordance with the SFN communication scheme.

In some examples, the first control message includes an RRC message and the second control message includes DCI. In some examples, the first physical downlink channel includes a PDCCH and the second physical downlink channel includes a PDSCH.

Additionally, or alternatively, the communications manager 920 may support wireless communication at a UE in accordance with examples as disclosed herein. In some examples, the SFN communication scheme component 925 may be configured as or otherwise support a means for receiving a first control message indicating a first parameter associated with a first SFN communication scheme applicable to a first physical downlink channel, or a second parameter associated with a second SFN communication scheme applicable to a second physical downlink channel, or both. In some examples, the TCI state component 930 may be configured as or otherwise support a means for receiving a second control message that indicates one or more TCI states from a set of TCI states. In some examples, the physical downlink channel processing component 935 may be configured as or otherwise support a means for receiving each of the first physical downlink channel and the second physical downlink channel using at least one TCI state of the one or more TCI states based on the first SFN communication scheme indicated by the first parameter, the second SFN communication scheme indicated by the second parameter, or both.

In some examples, the first control message may indicate the first parameter and the second parameter, and to support receiving each of the first physical downlink channel and the second physical downlink channel, the physical downlink channel processing component 935 may be configured as or otherwise support a means for receiving the first physical downlink channel using all of the one or more TCI states based on the first SFN communication scheme indicated by the first parameter, and the physical downlink channel processing component 935 may be configured as or otherwise support a means for receiving the second physical downlink channel using all of the one or more TCI states based on the second SFN communication scheme indicated by the second parameter. In some examples, a codepoint indicated by the second control message may include two TCI states from the set of TCI states.

In some examples, the first control message may indicate the first parameter and the second parameter, and to support receiving each of the first physical downlink channel and the second physical downlink channel, the physical downlink channel processing component 935 may be configured as or otherwise support a means for receiving the first physical downlink channel using all of the one or more TCI states based on the first SFN communication scheme indicated by the first parameter, and the physical downlink channel processing component 935 may be configured as or otherwise support a means for receiving the second physical downlink channel using a subset of the one or more TCI states based on the second SFN communication scheme indicated by the second parameter and a TCI state selection parameter. In some examples, the second control message may indicate the TCI state selection parameter.

In some examples, a codepoint indicated by the second control message may include two TCI states from the set of TCI states. In some examples, the subset includes one or both of the two TCI states. In some examples, the TCI state selection parameter may indicate a single TCI state or two TCI states to be applied for receipt of the second physical downlink channel.

In some examples, the threshold time period component 950 may be configured as or otherwise support a means for receiving a third control message that indicates a threshold time period for determining whether to include one or more TCI states indicated by the TCI state selection parameter in the subset of TCI states for receipt of the second physical downlink channel. In some examples, the threshold time period component 950 may be configured as or otherwise support a means for determining that a time period between a first time at which the second control message is received and a current time is greater than or equal to the threshold time period, where the subset of TCI states may include the one or more TCI states indicated by the TCI state selection parameter based on the time period being greater than or equal to the threshold time period.

In some examples, the threshold time period component 950 may be configured as or otherwise support a means for receiving a third control message that indicates a threshold time period for determining whether to include one or more TCI states indicated by the TCI state selection parameter in the subset of TCI states for receipt of the second physical downlink channel. In some examples, the threshold time period component 950 may be configured as or otherwise support a means for determining that a time period between a first time at which the second control message is received and a current time is less than the threshold time period, where the subset of TCI states may include one or more default TCI states based on the time period being less than the threshold time period, the one or more default TCI states configured for the second physical downlink channel.

In some examples, the first control message may indicate the first parameter and may exclude the second parameter, and to support receiving each of the first physical downlink channel and the second physical downlink channel, the physical downlink channel processing component 935 may be configured as or otherwise support a means for receiving the first physical downlink channel using all of the one or more TCI states indicated by the second control message based on the first SFN communication scheme indicated by the first parameter and receiving the second physical downlink channel using a subset of TCI states based on exclusion of the second parameter from the first control message.

In some examples, to support receiving each of the first physical downlink channel and the second physical downlink channel, the physical downlink channel processing component 935 may be configured as or otherwise support a means for receiving both the first physical downlink channel and the second physical downlink channel using a single TCI state based on the second control message indicating the single TCI state.

In some examples, the capability message generation component 940 may be configured as or otherwise support a means for transmitting a capability message indicating a capability of the UE to support SFN communications with multiple TRPs, where the second control message may indicate two or more TCI states based on the capability message.

In some examples, the first control message includes an RRC message and the second control message includes DCI. In some examples, to support receiving each of the first physical downlink channel and the second physical downlink channel, the multi-TRP SFN component 945 may be configured as or otherwise support a means for receiving both the first physical downlink channel and the second physical downlink channel from two or more TRPs.

In some examples, the first physical downlink channel includes a first type of physical downlink channel and the second physical downlink channel includes a second type of physical downlink channel that is different than the first type of physical downlink channel, each of the first type and the second type selected from one of a PDCCH or a PDSCH.

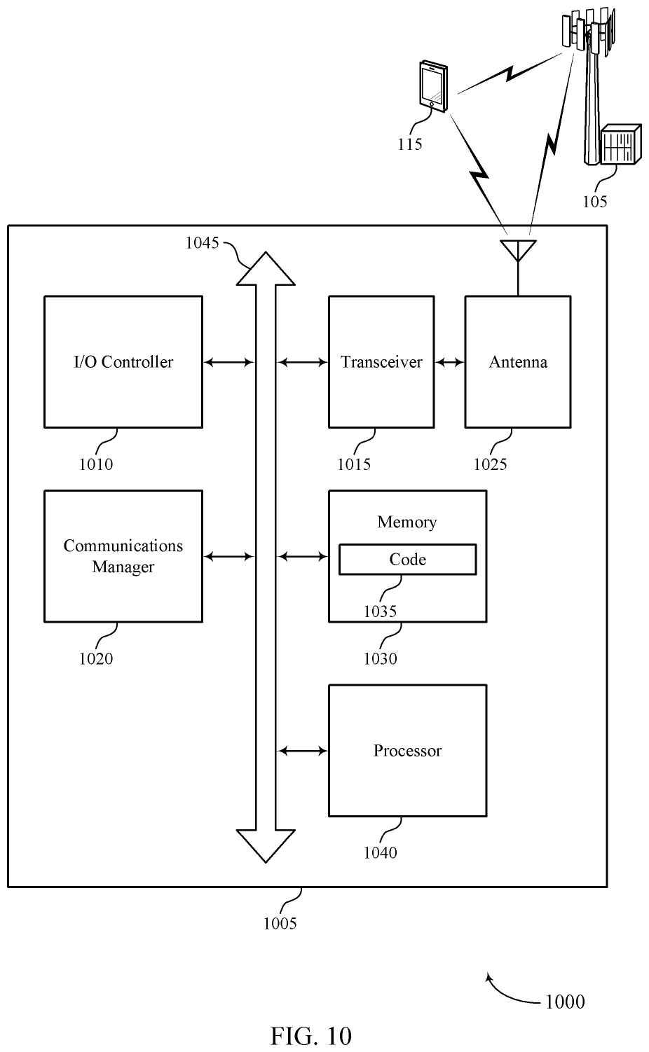

FIG. 10 shows a diagram of a system 1000 including a device 1005 that supports unified TCI state indication for SFNs in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting unified TCI state indication for SFNs). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving a first control message including a parameter that indicates an SFN communication scheme applicable to both a first physical downlink channel and a second physical downlink channel. The communications manager 1020 may be configured as or otherwise support a means for receiving a second control message indicating a set of one or more TCI states from a set of multiple TCI states. The communications manager 1020 may be configured as or otherwise support a means for receiving the first physical downlink channel and the second physical downlink channel using a subset of one or more TCI states, the subset of one or more TCI states selected from the set of one or more TCI states based on the SFN communication scheme indicated by the parameter.

Additionally, or alternatively, the communications manager 1020 may support wireless communication at a UE in accordance with examples as disclosed herein. For example, the communications manager 1020 may be configured as or otherwise support a means for receiving a first control message indicating a first parameter associated with a first SFN communication scheme applicable to a first physical downlink channel, or a second parameter associated with a second SFN communication scheme applicable to a second physical downlink channel, or both. The communications manager 1020 may be configured as or otherwise support a means for receiving a second control message that indicates one or more TCI states from a set of TCI states. The communications manager 1020 may be configured as or otherwise support a means for receiving each of the first physical downlink channel and the second physical downlink channel using at least one TCI state of the one or more TCI states based on the first SFN communication scheme indicated by the first parameter, the second SFN communication scheme indicated by the second parameter, or both.

By including or configuring the communications manager 1020 in accordance with examples as described herein, the device 1005 may support techniques for improved communication reliability, reduced latency, reduced power consumption, more efficient utilization of communication resources, improved coordination between devices, among other advantages. For example, the device 1005 (e.g., a UE) may receive a control message that includes one or more parameters that indicate SFN communication schemes for the device 1005. The parameters may indicate, to the processor of the device 1005, which TCI states may be applied for receipt of a given physical downlink channel that is transmitted from two or more TRPs in accordance with SFN communications. As such, the device 1005 may support SFN communications with two or more TRPs based on unified TCI state types. Such SFN communications may improve communication reliability and throughput. By utilizing the unified TCI state types, a network entity may refrain from transmitting additional control information to the device 1005 to indicate which TCI states to use for SFN communications, which may reduce latency, overhead, and power consumption.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of unified TCI state indication for SFNs as described herein, or the processor 1040 and the memory 1030 may be otherwise configured to perform or support such operations.

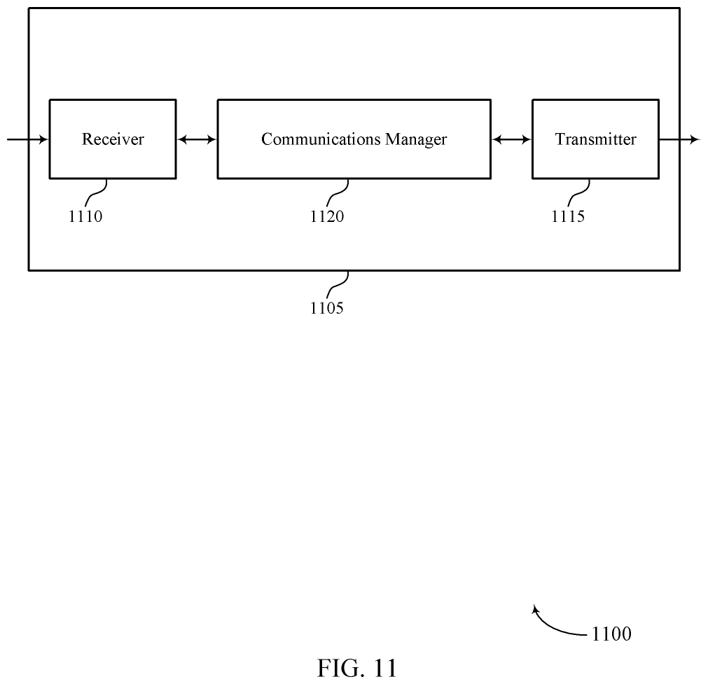

FIG. 11 shows a block diagram 1100 of a device 1105 that supports unified TCI state indication for SFNs in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of unified TCI state indication for SFNs as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting a first control message including a parameter that indicates an SFN communication scheme applicable to both a first physical downlink channel and a second physical downlink channel. The communications manager 1120 may be configured as or otherwise support a means for transmitting a second control message indicating a set of one or more TCI states from a set of multiple TCI states. The communications manager 1120 may be configured as or otherwise support a means for transmitting the first physical downlink channel and the second physical downlink channel in accordance with a subset of one or more TCI states, the subset of one or more TCI states selected from the set of one or more TCI states based on the SFN communication scheme indicated by the parameter.

Additionally, or alternatively, the communications manager 1120 may support wireless communication at a network entity in accordance with examples as disclosed herein. For example, the communications manager 1120 may be configured as or otherwise support a means for transmitting a first control message indicating a first parameter associated with a first SFN communication scheme applicable to a first physical downlink channel, or a second parameter associated with a second SFN communication scheme applicable to a second physical downlink channel, or both. The communications manager 1120 may be configured as or otherwise support a means for transmitting a second control message that indicates one or more TCI states from a set of TCI states. The communications manager 1120 may be configured as or otherwise support a means for transmitting each of the first physical downlink channel and the second physical downlink channel in accordance with at least one TCI state of the one or more TCI states based on the first SFN communication scheme indicated by the first parameter, the second SFN communication scheme indicated by the second parameter, or both.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing, reduced power consumption, and more efficient utilization of communication resources.

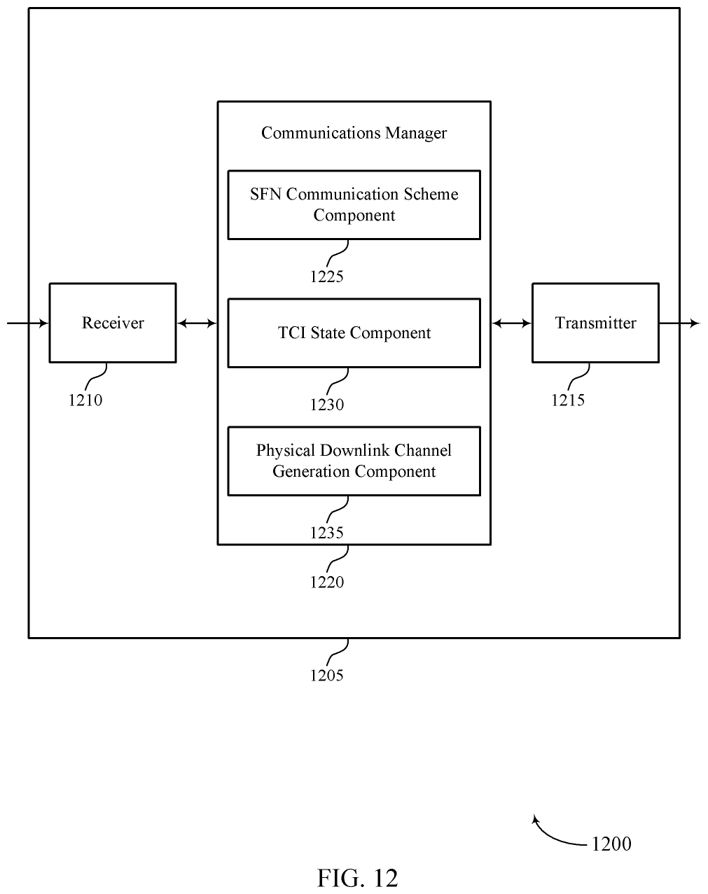

FIG. 12 shows a block diagram 1200 of a device 1205 that supports unified TCI state indication for SFNs in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of unified TCI state indication for SFNs as described herein. For example, the communications manager 1220 may include an SFN communication scheme component 1225, a TCI state component 1230, a physical downlink channel generation component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The SFN communication scheme component 1225 may be configured as or otherwise support a means for transmitting a first control message including a parameter that indicates an SFN communication scheme applicable to both a first physical downlink channel and a second physical downlink channel. The TCI state component 1230 may be configured as or otherwise support a means for transmitting a second control message indicating a set of one or more TCI states from a set of multiple TCI states. The physical downlink channel generation component 1235 may be configured as or otherwise support a means for transmitting the first physical downlink channel and the second physical downlink channel in accordance with a subset of one or more TCI states, the subset of one or more TCI states selected from the set of one or more TCI states based on the SFN communication scheme indicated by the parameter.

Additionally, or alternatively, the communications manager 1220 may support wireless communication at a network entity in accordance with examples as disclosed herein. The SFN communication scheme component 1225 may be configured as or otherwise support a means for transmitting a first control message indicating a first parameter associated with a first SFN communication scheme applicable to a first physical downlink channel, or a second parameter associated with a second SFN communication scheme applicable to a second physical downlink channel, or both. The TCI state component 1230 may be configured as or otherwise support a means for transmitting a second control message that indicates one or more TCI states from a set of TCI states. The physical downlink channel generation component 1235 may be configured as or otherwise support a means for transmitting each of the first physical downlink channel and the second physical downlink channel in accordance with at least one TCI state of the one or more TCI states based on the first SFN communication scheme indicated by the first parameter, the second SFN communication scheme indicated by the second parameter, or both.

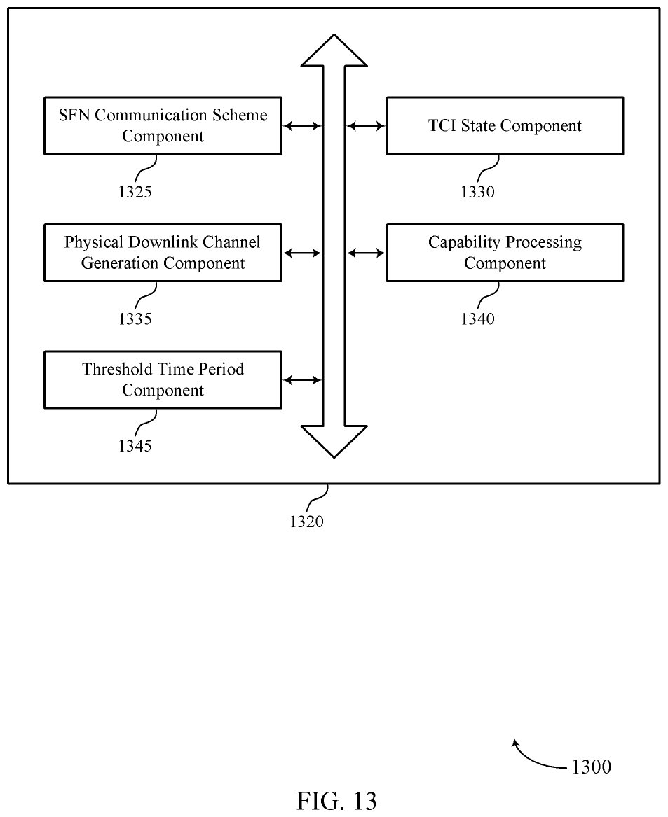

FIG. 13 shows a block diagram 1300 of a communications manager 1320 that supports unified TCI state indication for SFNs in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of unified TCI state indication for SFNs as described herein. For example, the communications manager 1320 may include an SFN communication scheme component 1325, a TCI state component 1330, a physical downlink channel generation component 1335, a capability processing component 1340, a threshold time period component 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The SFN communication scheme component 1325 may be configured as or otherwise support a means for transmitting a first control message including a parameter that indicates an SFN communication scheme applicable to both a first physical downlink channel and a second physical downlink channel. The TCI state component 1330 may be configured as or otherwise support a means for transmitting a second control message indicating a set of one or more TCI states from a set of multiple TCI states. The physical downlink channel generation component 1335 may be configured as or otherwise support a means for transmitting the first physical downlink channel and the second physical downlink channel in accordance with a subset of one or more TCI states, the subset of one or more TCI states selected from the set of one or more TCI states based on the SFN communication scheme indicated by the parameter.

In some examples, the SFN communication scheme may correspond to a first SFN communication scheme of a set of multiple SFN communication schemes, and to support transmitting the first physical downlink channel and the second physical downlink channel, the physical downlink channel generation component 1335 may be configured as or otherwise support a means for transmitting both the first physical downlink channel and the second physical downlink channel in accordance with each TCI state of the set of one or more TCI states indicated by the second control message based on the first SFN communication scheme.

In some examples, the SFN communication scheme may correspond to a second SFN communication scheme of a set of multiple SFN communication schemes, and to support transmitting the first physical downlink channel and the second physical downlink channel, the physical downlink channel generation component 1335 may be configured as or otherwise support a means for transmitting both the first physical downlink channel and the second physical downlink channel in accordance with a first set of QCL parameters associated with a first TCI state of the set of one or more TCI states and a second set of one or more QCL parameters associated with a second TCI state of the set of one or more TCI states based on the second SFN communication scheme, where the second set of one or more QCL parameters may exclude one or more QCL parameters.

In some examples, to support transmitting the first physical downlink channel and the second physical downlink channel, the physical downlink channel generation component 1335 may be configured as or otherwise support a means for transmitting both the first physical downlink channel and the second physical downlink channel in accordance with a single TCI state based on the second control message indicating the single TCI state.

In some examples, the capability processing component 1340 may be configured as or otherwise support a means for receiving, from a UE, a capability message indicating a capability of the UE to support SFN communications with multiple TRPs, where the second control message indicates one or more TCI states from the set of multiple TCI states based on the capability message.

In some examples, to support transmitting the first physical downlink channel and the second physical downlink channel, the physical downlink channel generation component 1335 may be configured as or otherwise support a means for transmitting both the first physical downlink channel and the second physical downlink channel from two or more TRPs of the network entity in accordance with the SFN communication scheme.

Additionally, or alternatively, the communications manager 1320 may support wireless communication at a network entity in accordance with examples as disclosed herein. In some examples, the SFN communication scheme component 1325 may be configured as or otherwise support a means for transmitting a first control message indicating a first parameter associated with a first SFN communication scheme applicable to a first physical downlink channel, or a second parameter associated with a second SFN communication scheme applicable to a second physical downlink channel, or both. In some examples, the TCI state component 1330 may be configured as or otherwise support a means for transmitting a second control message that indicates one or more TCI states from a set of TCI states. In some examples, the physical downlink channel generation component 1335 may be configured as or otherwise support a means for transmitting each of the first physical downlink channel and the second physical downlink channel in accordance with at least one TCI state of the one or more TCI states based on the first SFN communication scheme indicated by the first parameter, the second SFN communication scheme indicated by the second parameter, or both.

In some examples, the first control message may indicate the first parameter and the second parameter, and to support transmitting each of the first physical downlink channel and the second physical downlink channel, the physical downlink channel generation component 1335 may be configured as or otherwise support a means for transmitting the first physical downlink channel in accordance with all of the one or more TCI states based on the first SFN communication scheme indicated by the first parameter and a means for transmitting the second physical downlink channel in accordance with all of the one or more TCI states based on the second SFN communication scheme indicated by the second parameter.

In some examples, the first control message may indicate the first parameter and the second parameter, and to support transmitting each of the first physical downlink channel and the second physical downlink channel, the physical downlink channel generation component 1335 may be configured as or otherwise support a means for transmitting the first physical downlink channel in accordance with all of the one or more TCI states based on the first SFN communication scheme indicated by the first parameter and a means for transmitting the second physical downlink channel in accordance with a subset of the one or more TCI states based on the second SFN communication scheme indicated by the second parameter and a TCI state selection parameter. In some examples, the second control message may indicate the TCI state selection parameter.

In some examples, the threshold time period component 1345 may be configured as or otherwise support a means for transmitting a third control message that indicates a threshold time period for determining whether to include one or more TCI states indicated by the TCI state selection parameter in the subset of TCI states for transmission of the second physical downlink channel. In some examples, the threshold time period component 1345 may be configured as or otherwise support a means for determining that a time period between a first time at which the second control message is received and a current time is greater than or equal to the threshold time period, where the subset of TCI states may include the one or more TCI states indicated by the TCI state selection parameter based on the time period being greater than or equal to the threshold time period.

In some examples, the threshold time period component 1345 may be configured as or otherwise support a means for transmitting a third control message that indicates a threshold time period for determining whether to include one or more TCI states indicated by the TCI state selection parameter in the subset of TCI states for transmission of the second physical downlink channel. In some examples, the threshold time period component 1345 may be configured as or otherwise support a means for determining that a time period between a first time at which the second control message is received and a current time is less than the threshold time period, where the subset of TCI states may include one or more default TCI states based on the time period being less than the threshold time period, the one or more default TCI states configured for the second physical downlink channel.

In some examples, the first control message may indicate the first parameter and may exclude the second parameter, and to support transmitting each of the first physical downlink channel and the second physical downlink channel, the physical downlink channel generation component 1335 may be configured as or otherwise support a means for transmitting the first physical downlink channel in accordance with all of the one or more TCI states indicated by the second control message based on the first SFN communication scheme indicated by the first parameter and transmitting the second physical downlink channel in accordance with a subset of TCI states based on exclusion of the second parameter from the first control message.

In some examples, to support receiving each of the first physical downlink channel and the second physical downlink channel, the physical downlink channel generation component 1335 may be configured as or otherwise support a means for transmitting both the first physical downlink channel and the second physical downlink channel in accordance with a single TCI state based on the second control message indicating the single TCI state.

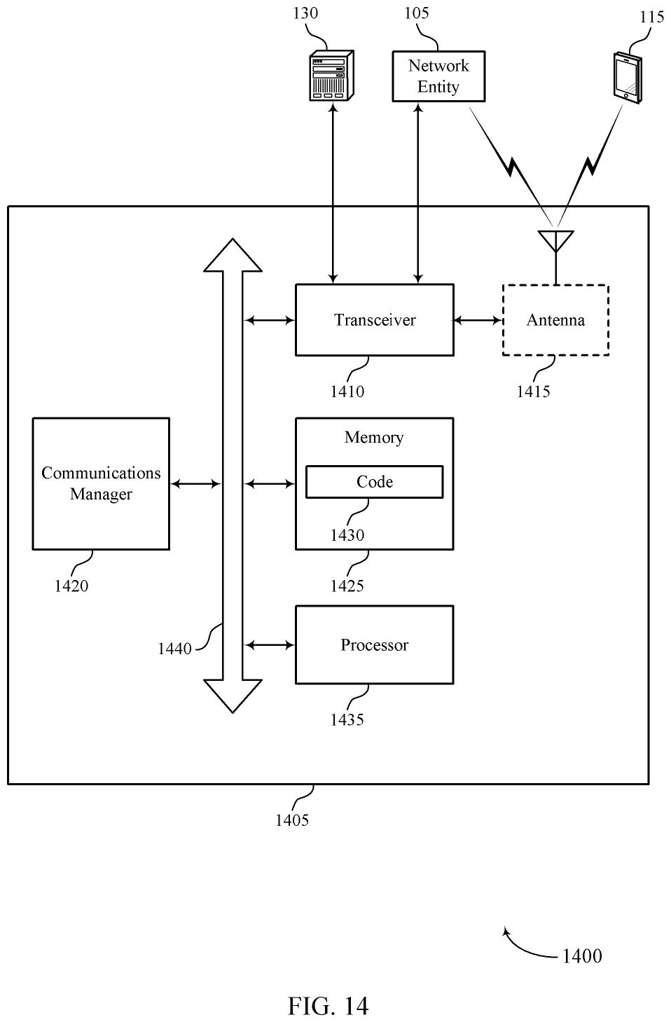

FIG. 14 shows a diagram of a system 1400 including a device 1405 that supports unified TCI state indication for SFNs in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting unified TCI state indication for SFNs). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting a first control message including a parameter that indicates an SFN communication scheme applicable to both a first physical downlink channel and a second physical downlink channel. The communications manager 1420 may be configured as or otherwise support a means for transmitting a second control message indicating a set of one or more TCI states from a set of multiple TCI states. The communications manager 1420 may be configured as or otherwise support a means for transmitting the first physical downlink channel and the second physical downlink channel in accordance with a subset of one or more TCI states, the subset of one or more TCI states selected from the set of one or more TCI states based on the SFN communication scheme indicated by the parameter.

Additionally, or alternatively, the communications manager 1420 may support wireless communication at a network entity in accordance with examples as disclosed herein. For example, the communications manager 1420 may be configured as or otherwise support a means for transmitting a first control message indicating a first parameter associated with a first SFN communication scheme applicable to a first physical downlink channel, or a second parameter associated with a second SFN communication scheme applicable to a second physical downlink channel, or both. The communications manager 1420 may be configured as or otherwise support a means for transmitting a second control message that indicates one or more TCI states from a set of TCI states. The communications manager 1420 may be configured as or otherwise support a means for transmitting each of the first physical downlink channel and the second physical downlink channel in accordance with at least one TCI state of the one or more TCI states based on the first SFN communication scheme indicated by the first parameter, the second SFN communication scheme indicated by the second parameter, or both.

By including or configuring the communications manager 1420 in accordance with examples as described herein, the device 1405 may support techniques for improved communication reliability, reduced latency, reduced power consumption, more efficient utilization of communication resources, improved coordination between devices, and longer battery life, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of unified TCI state indication for SFNs as described herein, or the processor 1435 and the memory 1425 may be otherwise configured to perform or support such operations.

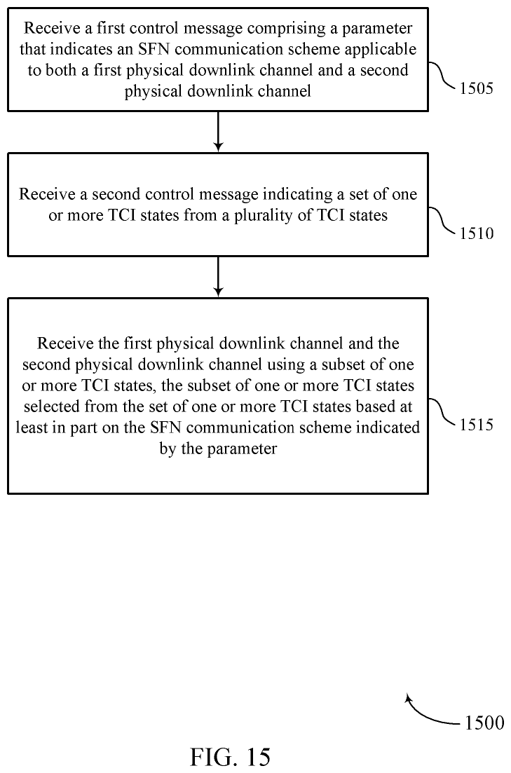

FIG. 15 shows a flowchart illustrating a method 1500 that supports unified TCI state indication for SFNs in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a first control message including a parameter that indicates an SFN communication scheme applicable to both a first physical downlink channel and a second physical downlink channel. The operations of 1505 may be performed in accordance with examples as disclosed herein. In some examples, aspects of the operations of 1505 may be performed by an SFN communication scheme component 925 as described with reference to FIG. 9.

At 1510, the method may include receiving a second control message indicating a set of one or more TCI states from a set of multiple TCI states. The operations of 1510 may be performed in accordance with examples as disclosed herein. In some examples, aspects of the operations of 1510 may be performed by a TCI state component 930 as described with reference to FIG. 9.

At 1515, the method may include receiving the first physical downlink channel and the second physical downlink channel using a subset of one or more TCI states, the subset of one or more TCI states selected from the set of one or more TCI states based on the SFN communication scheme indicated by the parameter. The operations of 1515 may be performed in accordance with examples as disclosed herein. In some examples, aspects of the operations of 1515 may be performed by a physical downlink channel processing component 935 as described with reference to FIG. 9.

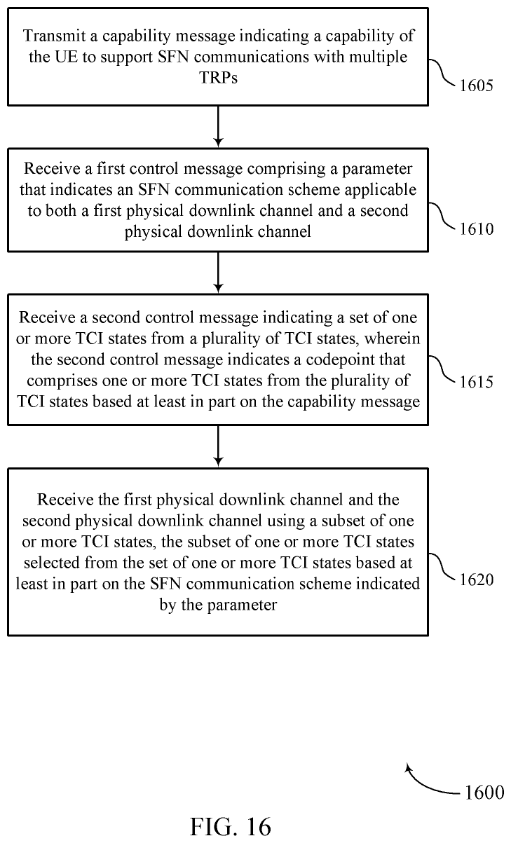

FIG. 16 shows a flowchart illustrating a method 1600 that supports unified TCI state indication for SFNs in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting a capability message indicating a capability of the UE to support SFN communications with multiple transmission and reception points, where the second control message indicates a codepoint that includes one or more TCI states from the set of multiple TCI states based on the capability message. The operations of 1605 may be performed in accordance with examples as disclosed herein. In some examples, aspects of the operations of 1605 may be performed by a capability message generation component 940 as described with reference to FIG. 9.

At 1610, the method may include receiving a first control message including a parameter that indicates an SFN communication scheme applicable to both a first physical downlink channel and a second physical downlink channel. The operations of 1610 may be performed in accordance with examples as disclosed herein. In some examples, aspects of the operations of 1610 may be performed by an SFN communication scheme component 925 as described with reference to FIG. 9.

At 1615, the method may include receiving a second control message indicating a set of one or more TCI states from a set of multiple TCI states. The operations of 1615 may be performed in accordance with examples as disclosed herein. In some examples, aspects of the operations of 1615 may be performed by a TCI state component 930 as described with reference to FIG. 9.

At 1620, the method may include receiving the first physical downlink channel and the second physical downlink channel using a subset of one or more TCI states, the subset of one or more TCI states selected from the set of one or more TCI states based on the SFN communication scheme indicated by the parameter. The operations of 1620 may be performed in accordance with examples as disclosed herein. In some examples, aspects of the operations of 1620 may be performed by a physical downlink channel processing component 935 as described with reference to FIG. 9.

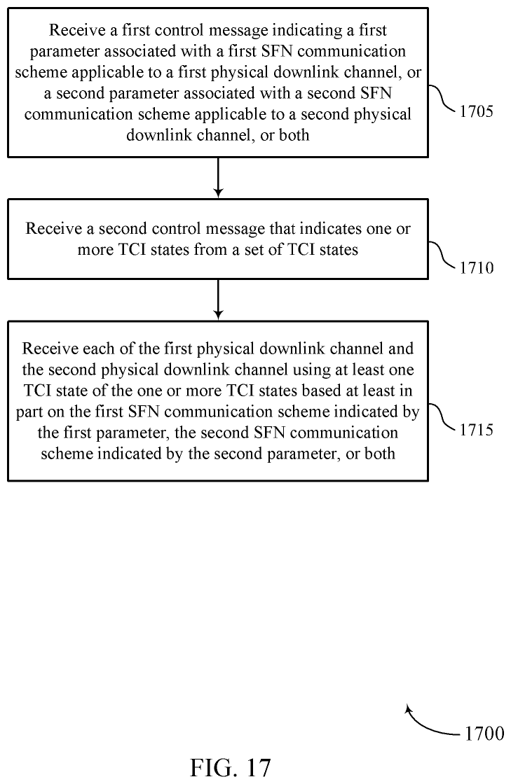

FIG. 17 shows a flowchart illustrating a method 1700 that supports unified TCI state indication for SFNs in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving a first control message indicating a first parameter associated with a first SFN communication scheme applicable to a first physical downlink channel, or a second parameter associated with a second SFN communication scheme applicable to a second physical downlink channel, or both. The operations of 1705 may be performed in accordance with examples as disclosed herein. In some examples, aspects of the operations of 1705 may be performed by an SFN communication scheme component 925 as described with reference to FIG. 9.

At 1710, the method may include receiving a second control message that indicates one or more TCI states from a set of TCI states. The operations of 1710 may be performed in accordance with examples as disclosed herein. In some examples, aspects of the operations of 1710 may be performed by a TCI state component 930 as described with reference to FIG. 9.

At 1715, the method may include receiving each of the first physical downlink channel and the second physical downlink channel using at least one TCI state of the one or more TCI states based on the first SFN communication scheme indicated by the first parameter, the second SFN communication scheme indicated by the second parameter, or both. The operations of 1715 may be performed in accordance with examples as disclosed herein. In some examples, aspects of the operations of 1715 may be performed by a physical downlink channel processing component 935 as described with reference to FIG. 9.

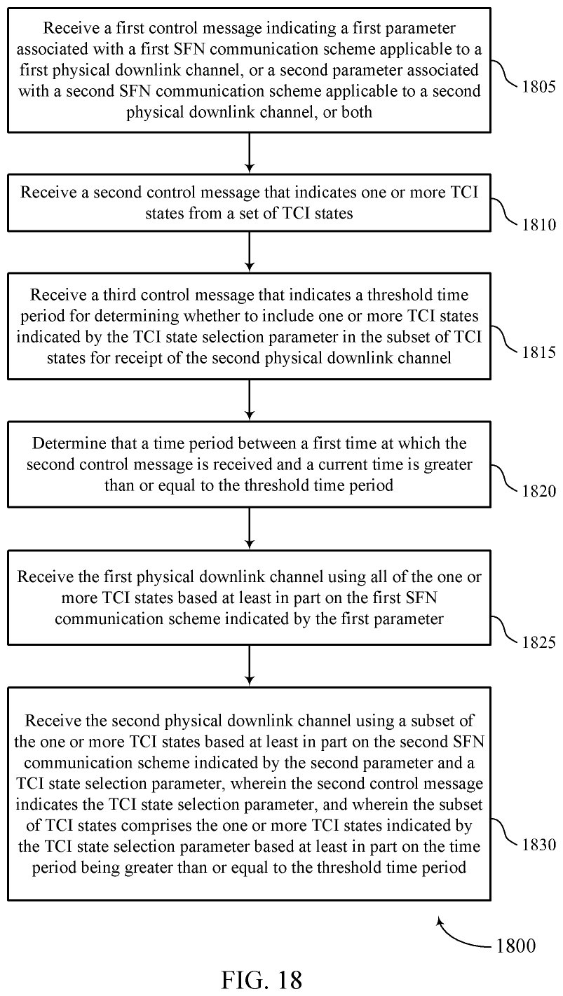

FIG. 18 shows a flowchart illustrating a method 1800 that supports unified TCI state indication for SFNs in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving a first control message indicating a first parameter associated with a first SFN communication scheme applicable to a first physical downlink channel, or a second parameter associated with a second SFN communication scheme applicable to a second physical downlink channel, or both. The operations of 1805 may be performed in accordance with examples as disclosed herein. In some examples, aspects of the operations of 1805 may be performed by an SFN communication scheme component 925 as described with reference to FIG. 9.

At 1810, the method may include receiving a second control message that indicates one or more TCI states from a set of TCI states. The operations of 1810 may be performed in accordance with examples as disclosed herein. In some examples, aspects of the operations of 1810 may be performed by a TCI state component 930 as described with reference to FIG. 9.

At 1815, the method may include receiving a third control message that indicates a threshold time period for determining whether to include one or more TCI states indicated by the TCI state selection parameter in the subset of TCI states for receipt of the second physical downlink channel. The operations of 1815 may be performed in accordance with examples as disclosed herein. In some examples, aspects of the operations of 1815 may be performed by a threshold time period component 950 as described with reference to FIG. 9.

At 1820, the method may include determining that a time period between a first time at which the second control message is received and a current time is greater than or equal to the threshold time period, where the subset of TCI states includes the one or more TCI states indicated by the TCI state selection parameter based on the time period being greater than or equal to the threshold time period. The operations of 1820 may be performed in accordance with examples as disclosed herein. In some examples, aspects of the operations of 1820 may be performed by a threshold time period component 950 as described with reference to FIG. 9.

At 1825, the method may include receiving each of the first physical downlink channel and the second physical downlink channel using at least one TCI state of the one or more TCI states based on the first SFN communication scheme indicated by the first parameter, the second SFN communication scheme indicated by the second parameter, or both. The operations of 1825 may be performed in accordance with examples as disclosed herein. In some examples, aspects of the operations of 1825 may be performed by a physical downlink channel processing component 935 as described with reference to FIG. 9.

At 1830, the method may include receiving the first physical downlink channel using all of the one or more TCI states based on the first SFN communication scheme indicated by the first parameter. The operations of 1830 may be performed in accordance with examples as disclosed herein. In some examples, aspects of the operations of 1830 may be performed by a physical downlink channel processing component 935 as described with reference to FIG. 9.

At 1835, the method may include receiving the second physical downlink channel using a subset of the one or more TCI states based on the second SFN communication scheme indicated by the second parameter and a TCI state selection parameter, where the second control message indicates the TCI state selection parameter. The operations of 1835 may be performed in accordance with examples as disclosed herein. In some examples, aspects of the operations of 1835 may be performed by a physical downlink channel processing component 935 as described with reference to FIG. 9.

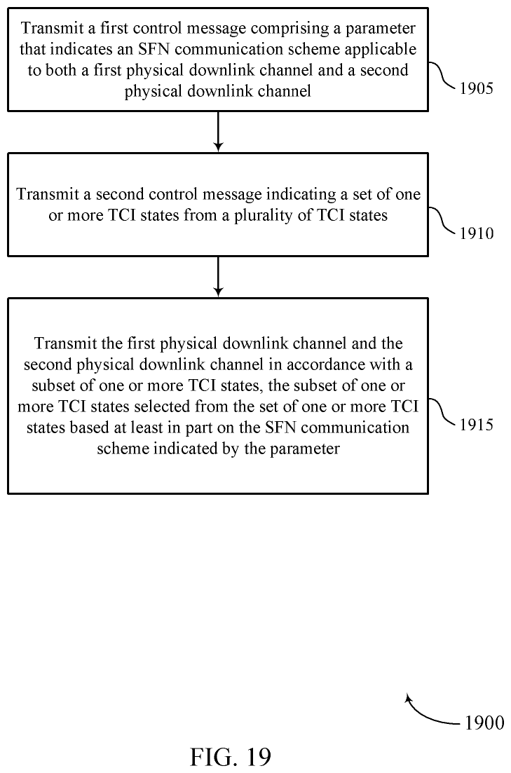

FIG. 19 shows a flowchart illustrating a method 1900 that supports unified TCI state indication for SFNs in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a first control message including a parameter that indicates an SFN communication scheme applicable to both a first physical downlink channel and a second physical downlink channel. The operations of 1905 may be performed in accordance with examples as disclosed herein. In some examples, aspects of the operations of 1905 may be performed by an SFN communication scheme component 1325 as described with reference to FIG. 13.

At 1910, the method may include transmitting a second control message indicating a set of one or more TCI states from a set of multiple TCI states. The operations of 1910 may be performed in accordance with examples as disclosed herein. In some examples, aspects of the operations of 1910 may be performed by a TCI state component 1330 as described with reference to FIG. 13.

At 1915, the method may include transmitting the first physical downlink channel and the second physical downlink channel in accordance with a subset of one or more TCI states, the subset of one or more TCI states selected from the set of one or more TCI states based on the SFN communication scheme indicated by the parameter. The operations of 1915 may be performed in accordance with examples as disclosed herein. In some examples, aspects of the operations of 1915 may be performed by a physical downlink channel generation component 1335 as described with reference to FIG. 13.

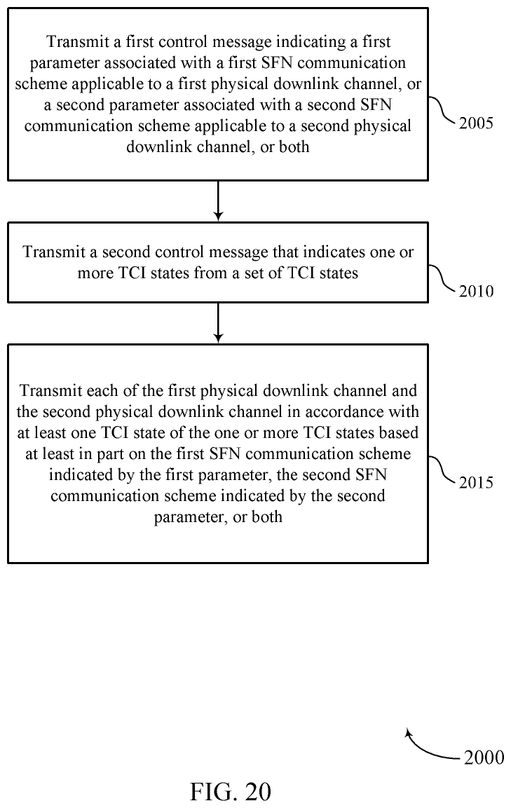

FIG. 20 shows a flowchart illustrating a method 2000 that supports unified TCI state indication for SFNs in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting a first control message indicating a first parameter associated with a first SFN communication scheme applicable to a first physical downlink channel, or a second parameter associated with a second SFN communication scheme applicable to a second physical downlink channel, or both. The operations of 2005 may be performed in accordance with examples as disclosed herein. In some examples, aspects of the operations of 2005 may be performed by an SFN communication scheme component 1325 as described with reference to FIG. 13.

At 2010, the method may include transmitting a second control message that indicates one or more TCI states from a set of TCI states. The operations of 2010 may be performed in accordance with examples as disclosed herein. In some examples, aspects of the operations of 2010 may be performed by a TCI state component 1330 as described with reference to FIG. 13.

At 2015, the method may include transmitting each of the first physical downlink channel and the second physical downlink channel in accordance with at least one TCI state of the one or more TCI states based on the first SFN communication scheme indicated by the first parameter, the second SFN communication scheme indicated by the second parameter, or both. The operations of 2015 may be performed in accordance with examples as disclosed herein. In some examples, aspects of the operations of 2015 may be performed by a physical downlink channel generation component 1335 as described with reference to FIG. 13.

The following provides an overview of aspects of the present disclosure:

Aspect 1: A method for wireless communication at a UE, comprising: receiving a first control message comprising a parameter that indicates an SFN communication scheme applicable to both a first physical downlink channel and a second physical downlink channel; receiving a second control message indicating a set of one or more TCI states from a plurality of TCI states; and receiving the first physical downlink channel and the second physical downlink channel using a subset of one or more TCI states, the subset of one or more TCI states selected from the set of one or more TCI states based at least in part on the SFN communication scheme indicated by the parameter.

Aspect 2: The method of aspect 1, wherein the SFN communication scheme corresponds to a first SFN communication scheme of a plurality of SFN communication schemes, and wherein receiving the first physical downlink channel and the second physical downlink channel comprises: receiving both the first physical downlink channel and the second physical downlink channel using each TCI state of the set of one or more TCI states indicated by the second control message based at least in part on the first SFN communication scheme.

Aspect 3: The method of aspect 2, wherein a codepoint indicated by the second control message comprises two TCI states from the plurality of TCI states.

Aspect 4: The method of aspect 1, wherein the SFN communication scheme corresponds to a second SFN communication scheme of a plurality of SFN communication schemes, and wherein receiving the first physical downlink channel and the second physical downlink channel comprises: receiving both the first physical downlink channel and the second physical downlink channel using a first set of QCL parameters associated with a first TCI state of the set of one or more TCI states and a second set of one or more QCL parameters associated with a second TCI state of the set of one or more TCI states based at least in part on the second SFN communication scheme, wherein the second set of one or more QCL parameters excludes one or more QCL parameters.

Aspect 5: The method of aspect 4, wherein the first set of QCL parameters comprises a doppler shift parameter, a doppler spread parameter, a delay shift parameter, a delay spread parameter, or any combination thereof; and the second set of one or more QCL parameters excludes one or more parameters of the first set of QCL parameters.

Aspect 6: The method of any of aspects 4 through 5, wherein a codepoint indicated by the second control message comprises two TCI states from the plurality of TCI states.

Aspect 7: The method of any of aspects 1 through 6, wherein receiving the first physical downlink channel and the second physical downlink channel comprises: receiving both the first physical downlink channel and the second physical downlink channel using a single TCI state based at least in part on the second control message indicating the single TCI state.

Aspect 8: The method of any of aspects 1 through 7, further comprising: transmitting a capability message indicating a capability of the UE to support SFN communications with multiple TRPs, wherein the second control message indicates a codepoint that comprises one or more TCI states from the plurality of TCI states based at least in part on the capability message.

Aspect 9: The method of any of aspects 1 through 8, wherein the first control message comprises an RRC message and the second control message comprises DCI.

Aspect 10: The method of any of aspects 1 through 9, wherein receiving the first physical downlink channel and the second physical downlink channel comprises: receiving both the first physical downlink channel and the second physical downlink channel from two or more TRPs in accordance with the SFN communication scheme.

Aspect 11: The method of any of aspects 1 through 10, wherein the first physical downlink channel comprises a PDCCH and the second physical downlink channel comprises a PDSCH.

Aspect 12: A method for wireless communication at a UE, comprising: receiving a first control message indicating a first parameter associated with a first SFN communication scheme applicable to a first physical downlink channel, or a second parameter associated with a second SFN communication scheme applicable to a second physical downlink channel, or both; receiving a second control message that indicates one or more TCI states from a set of TCI states; and receiving each of the first physical downlink channel and the second physical downlink channel using at least one TCI state of the one or more TCI states based at least in part on the first SFN communication scheme indicated by the first parameter, the second SFN communication scheme indicated by the second parameter, or both.

Aspect 13: The method of aspect 12, wherein the first control message indicates the first parameter and the second parameter, and wherein receiving each of the first physical downlink channel and the second physical downlink channel comprises: receiving the first physical downlink channel using all of the one or more TCI states based at least in part on the first SFN communication scheme indicated by the first parameter; and receiving the second physical downlink channel using all of the one or more TCI states based at least in part on the second SFN communication scheme indicated by the second parameter.

Aspect 14: The method of aspect 13, wherein a codepoint indicated by the second control message comprises two TCI states from the set of TCI states.

Aspect 15: The method of aspect 12, wherein the first control message indicates the first parameter and the second parameter, and wherein receiving each of the first physical downlink channel and the second physical downlink channel comprises: receiving the first physical downlink channel using all of the one or more TCI states based at least in part on the first SFN communication scheme indicated by the first parameter; and receiving the second physical downlink channel using a subset of the one or more TCI states based at least in part on the second SFN communication scheme indicated by the second parameter and a TCI state selection parameter, wherein the second control message indicates the TCI state selection parameter.

Aspect 16: The method of aspect 15, wherein a codepoint indicated by the second control message comprises two TCI states from the set of TCI states; and the subset comprises one or both of the two TCI states.

Aspect 17: The method of any of aspects 15 through 16, wherein the TCI state selection parameter indicates a single TCI state or two TCI states to be applied for receipt of the second physical downlink channel.

Aspect 18: The method of any of aspects 15 through 17, further comprising: receiving a third control message that indicates a threshold time period for determining whether to include one or more TCI states indicated by the TCI state selection parameter in the subset of TCI states for receipt of the second physical downlink channel; and determining that a time period between a first time at which the second control message is received and a current time is greater than or equal to the threshold time period, wherein the subset of TCI states comprises the one or more TCI states indicated by the TCI state selection parameter based at least in part on the time period being greater than or equal to the threshold time period.

Aspect 19: The method of any of aspects 15 through 17, further comprising: receiving a third control message that indicates a threshold time period for determining whether to include one or more TCI states indicated by the TCI state selection parameter in the subset of TCI states for receipt of the second physical downlink channel; and determining that a time period between a first time at which the second control message is received and a current time is less than the threshold time period, wherein the subset of TCI states comprises one or more default TCI states based at least in part on the time period being less than the threshold time period, the one or more default TCI states configured for the second physical downlink channel.

Aspect 20: The method of aspect 12, wherein the first control message indicates the first parameter and excludes the second parameter, and wherein receiving each of the first physical downlink channel and the second physical downlink channel comprises: receiving the first physical downlink channel using all of the one or more TCI states indicated by the second control message based at least in part on the first SFN communication scheme indicated by the first parameter; and receiving the second physical downlink channel using a subset of TCI states based at least in part on exclusion of the second parameter from the first control message.

Aspect 21: The method of any of aspects 12 through 20, wherein receiving each of the first physical downlink channel and the second physical downlink channel comprises: receiving both the first physical downlink channel and the second physical downlink channel using a single TCI state based at least in part on the second control message indicating the single TCI state.

Aspect 22: The method of any of aspects 12 through 21, further comprising: transmitting a capability message indicating a capability of the UE to support SFN communications with multiple TRPs, wherein the second control message indicates two or more TCI states based at least in part on the capability message.

Aspect 23: The method of any of aspects 12 through 22, wherein the first control message comprises an RRC message and the second control message comprises DCI.

Aspect 24: The method of any of aspects 12 through 23, wherein receiving each of the first physical downlink channel and the second physical downlink channel comprises: receiving both the first physical downlink channel and the second physical downlink channel from two or more TRPs.

Aspect 25: The method of any of aspects 12 through 24, wherein the first physical downlink channel comprises a first type of physical downlink channel and the second physical downlink channel comprises a second type of physical downlink channel that is different than the first type of physical downlink channel, each of the first type and the second type selected from one of a PDCCH or a PDSCH.

Aspect 26: A method for wireless communication at a network entity, comprising: transmitting a first control message comprising a parameter that indicates an SFN communication scheme applicable to both a first physical downlink channel and a second physical downlink channel; transmitting a second control message indicating a set of one or more TCI states from a plurality of TCI states; and transmitting the first physical downlink channel and the second physical downlink channel in accordance with a subset of one or more TCI states, the subset of one or more TCI states selected from the set of one or more TCI states based at least in part on the SFN communication scheme indicated by the parameter.

Aspect 27: The method of aspect 26, wherein the SFN communication scheme corresponds to a first SFN communication scheme of a plurality of SFN communication schemes, and wherein transmitting the first physical downlink channel and the second physical downlink channel comprises: transmitting both the first physical downlink channel and the second physical downlink channel in accordance with each TCI state of the set of one or more TCI states indicated by the second control message based at least in part on the first SFN communication scheme.

Aspect 28: The method of aspect 26, wherein the SFN communication scheme corresponds to a second SFN communication scheme of a plurality of SFN communication schemes, and wherein transmitting the first physical downlink channel and the second physical downlink channel comprises: transmitting both the first physical downlink channel and the second physical downlink channel in accordance with a first set of QCL parameters associated with a first TCI state of the set of one or more TCI states and a second set of one or more QCL parameters associated with a second TCI state of the set of one or more TCI states based at least in part on the second SFN communication scheme, wherein the second set of one or more QCL parameters excludes one or more QCL parameters.

Aspect 29: The method of any of aspects 26 through 28, wherein transmitting the first physical downlink channel and the second physical downlink channel comprises: transmitting both the first physical downlink channel and the second physical downlink channel in accordance with a single TCI state based at least in part on the second control message indicating the single TCI state.

Aspect 30: The method of any of aspects 26 through 29, further comprising: receiving, from a UE, a capability message indicating a capability of the UE to support SFN communications with multiple TRPs, wherein the second control message indicates one or more TCI states from the plurality of TCI states based at least in part on the capability message.

Aspect 31: The method of any of aspects 26 through 30, wherein transmitting the first physical downlink channel and the second physical downlink channel comprises: transmitting both the first physical downlink channel and the second physical downlink channel from two or more TRPs of the network entity in accordance with the SFN communication scheme.

Aspect 32: A method for wireless communication at a network entity, comprising: transmitting a first control message indicating a first parameter associated with a first SFN communication scheme applicable to a first physical downlink channel, or a second parameter associated with a second SFN communication scheme applicable to a second physical downlink channel, or both; transmitting a second control message that indicates one or more TCI states from a set of TCI states; and transmitting each of the first physical downlink channel and the second physical downlink channel in accordance with at least one TCI state of the one or more TCI states based at least in part on the first SFN communication scheme indicated by the first parameter, the second SFN communication scheme indicated by the second parameter, or both.

Aspect 33: The method of aspect 32, wherein the first control message indicates the first parameter and the second parameter, and wherein transmitting each of the first physical downlink channel and the second physical downlink channel comprises: transmitting the first physical downlink channel in accordance with all of the one or more TCI states based at least in part on the first SFN communication scheme indicated by the first parameter; and transmitting the second physical downlink channel in accordance with all of the one or more TCI states based at least in part on the second SFN communication scheme indicated by the second parameter.

Aspect 34: The method of aspect 32, wherein the first control message indicates the first parameter and the second parameter, and wherein transmitting each of the first physical downlink channel and the second physical downlink channel comprises: transmitting the first physical downlink channel in accordance with all of the one or more TCI states based at least in part on the first SFN communication scheme indicated by the first parameter; and transmitting the second physical downlink channel in accordance with a subset of the one or more TCI states based at least in part on the second SFN communication scheme indicated by the second parameter and a TCI state selection parameter, wherein the second control message indicates the TCI state selection parameter.

Aspect 35: The method of aspect 34, further comprising: transmitting a third control message that indicates a threshold time period for determining whether to include one or more TCI states indicated by the TCI state selection parameter in the subset of TCI states for transmission of the second physical downlink channel; and determining that a time period between a first time at which the second control message is received and a current time is greater than or equal to the threshold time period, wherein the subset of TCI states comprises the one or more TCI states indicated by the TCI state selection parameter based at least in part on the time period being greater than or equal to the threshold time period.

Aspect 36: The method of aspect 34, further comprising: transmitting a third control message that indicates a threshold time period for determining whether to include one or more TCI states indicated by the TCI state selection parameter in the subset of TCI states for transmission of the second physical downlink channel; and determining that a time period between a first time at which the second control message is received and a current time is less than the threshold time period, wherein the subset of TCI states comprises one or more default TCI states based at least in part on the time period being less than the threshold time period, the one or more default TCI states configured for the second physical downlink channel.

Aspect 37: The method of aspect 32, wherein the first control message indicates the first parameter and excludes the second parameter, and wherein transmitting each of the first physical downlink channel and the second physical downlink channel comprises: transmitting the first physical downlink channel in accordance with all of the one or more TCI states indicated by the second control message based at least in part on the first SFN communication scheme indicated by the first parameter; and transmitting the second physical downlink channel in accordance with a subset of TCI states based at least in part on exclusion of the second parameter from the first control message.

Aspect 38: The method of any of aspects 32 through 37, wherein receiving each of the first physical downlink channel and the second physical downlink channel comprises: transmitting both the first physical downlink channel and the second physical downlink channel in accordance with a single TCI state based at least in part on the second control message indicating the single TCI state.

Aspect 39: An apparatus for wireless communication at a UE, comprising a processor; memory coupled with the processor; and instructions stored in the memory and executable by the processor to cause the apparatus to perform a method of any of aspects 1 through 11.

Aspect 40: An apparatus for wireless communication at a UE, comprising at least one means for performing a method of any of aspects 1 through 11.

Aspect 41: A non-transitory computer-readable medium storing code for wireless communication at a UE, the code comprising instructions executable by a processor to perform a method of any of aspects 1 through 11.

Aspect 42: An apparatus for wireless communication at a UE, comprising a processor; memory coupled with the processor; and instructions stored in the memory and executable by the processor to cause the apparatus to perform a method of any of aspects 12 through 25.

Aspect 43: An apparatus for wireless communication at a UE, comprising at least one means for performing a method of any of aspects 12 through 25.

Aspect 44: A non-transitory computer-readable medium storing code for wireless communication at a UE, the code comprising instructions executable by a processor to perform a method of any of aspects 12 through 25.

Aspect 45: An apparatus for wireless communication at a network entity, comprising a processor; memory coupled with the processor; and instructions stored in the memory and executable by the processor to cause the apparatus to perform a method of any of aspects 26 through 31.

Aspect 46: An apparatus for wireless communication at a network entity, comprising at least one means for performing a method of any of aspects 26 through 31.

Aspect 47: A non-transitory computer-readable medium storing code for wireless communication at a network entity, the code comprising instructions executable by a processor to perform a method of any of aspects 26 through 31.

Aspect 48: An apparatus for wireless communication at a network entity, comprising a processor; memory coupled with the processor; and instructions stored in the memory and executable by the processor to cause the apparatus to perform a method of any of aspects 32 through 38.

Aspect 49: An apparatus for wireless communication at a network entity, comprising at least one means for performing a method of any of aspects 32 through 38.

Aspect 50: A non-transitory computer-readable medium storing code for wireless communication at a network entity, the code comprising instructions executable by a processor to perform a method of any of aspects 32 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first control message comprising a parameter that indicates a single-frequency network communication scheme applicable to both a first physical downlink channel and a second physical downlink channel;
receiving a second control message indicating a set of one or more transmission configuration indicator states from a plurality of transmission configuration indicator states; and
receiving the first physical downlink channel and the second physical downlink channel using a subset of one or more transmission configuration indicator states, the subset of one or more transmission configuration indicator states selected from the set of one or more transmission configuration indicator states based at least in part on the single-frequency network communication scheme indicated by the parameter.

2. The method of claim 1, wherein the single-frequency network communication scheme corresponds to a first single-frequency network communication scheme of a plurality of single-frequency network communication schemes, and wherein receiving the first physical downlink channel and the second physical downlink channel comprises:
receiving both the first physical downlink channel and the second physical downlink channel using each transmission configuration indicator state of the set of one or more transmission configuration indicator states indicated by the second control message based at least in part on the first single-frequency network communication scheme.

3. The method of claim 2, wherein a codepoint indicated by the second control message comprises two transmission configuration indicator states from the plurality of transmission configuration indicator states.

4. The method of claim 1, wherein the single-frequency network communication scheme corresponds to a second single-frequency network communication scheme of a plurality of single-frequency network communication schemes, and wherein receiving the first physical downlink channel and the second physical downlink channel comprises:
receiving both the first physical downlink channel and the second physical downlink channel using a first set of quasi co-location parameters associated with a first transmission configuration indicator state of the set of one or more transmission configuration indicator states and a second set of one or more quasi co-location parameters associated with a second transmission configuration indicator state of the set of one or more transmission configuration indicator states based at least in part on the second single-frequency network communication scheme, wherein the second set of one or more quasi co-location parameters excludes one or more quasi co-location parameters.

5. The method of claim 4, wherein:
the first set of quasi co-location parameters comprises a doppler shift parameter, a doppler spread parameter, a delay shift parameter, a delay spread parameter, or any combination thereof; and
the second set of one or more quasi co-location parameters excludes one or more parameters of the first set of quasi co-location parameters.

6. The method of claim 4, wherein a codepoint indicated by the second control message comprises two transmission configuration indicator states from the plurality of transmission configuration indicator states.

7. The method of claim 1, wherein receiving the first physical downlink channel and the second physical downlink channel comprises:
receiving both the first physical downlink channel and the second physical downlink channel using a single transmission configuration indicator state based at least in part on the second control message indicating the single transmission configuration indicator state.

8. The method of claim 1, further comprising:
transmitting a capability message indicating a capability of the UE to support single-frequency network communications with multiple transmission and reception points, wherein the second control message indicates a codepoint that comprises one or more transmission configuration indicator states from the plurality of transmission configuration indicator states based at least in part on the capability message.

9. The method of claim 1, wherein the first control message comprises a radio resource control message and the second control message comprises downlink control information.

10. The method of claim 1, wherein receiving the first physical downlink channel and the second physical downlink channel comprises:
receiving both the first physical downlink channel and the second physical downlink channel from two or more transmission and reception points in accordance with the single-frequency network communication scheme.

11. The method of claim 1, wherein the first physical downlink channel comprises a physical downlink control channel and the second physical downlink channel comprises a physical downlink shared channel.

12. A method for wireless communication at a user equipment (UE), comprising:
receiving a first control message indicating a first parameter associated with a first single-frequency network communication scheme applicable to a first physical downlink channel, or a second parameter associated with a second single-frequency network communication scheme applicable to a second physical downlink channel, or both;
receiving a second control message that indicates one or more transmission configuration indicator states from a set of transmission configuration indicator states; and
receiving each of the first physical downlink channel and the second physical downlink channel using at least one transmission configuration indicator state of the one or more transmission configuration indicator states based at least in part on the first single-frequency network communication scheme indicated by the first parameter, the second single-frequency network communication scheme indicated by the second parameter, or both.

13. The method of claim 12, wherein the first control message indicates the first parameter and the second parameter, and wherein receiving each of the first physical downlink channel and the second physical downlink channel comprises:
receiving the first physical downlink channel using all of the one or more transmission configuration indicator states based at least in part on the first single-frequency network communication scheme indicated by the first parameter; and
receiving the second physical downlink channel using all of the one or more transmission configuration indicator states based at least in part on the second single-frequency network communication scheme indicated by the second parameter.

14. The method of claim 13, wherein a codepoint indicated by the second control message comprises two transmission configuration indicator states from the set of transmission configuration indicator states.

15. The method of claim 12, wherein the first control message indicates the first parameter and the second parameter, and wherein receiving each of the first physical downlink channel and the second physical downlink channel comprises:
receiving the first physical downlink channel using all of the one or more transmission configuration indicator states based at least in part on the first single-frequency network communication scheme indicated by the first parameter; and
receiving the second physical downlink channel using a subset of the one or more transmission configuration indicator states based at least in part on the second single-frequency network communication scheme indicated by the second parameter and a transmission configuration indicator state selection parameter, wherein the second control message indicates the transmission configuration indicator state selection parameter.

16. The method of claim 15, wherein:
a codepoint indicated by the second control message comprises two transmission configuration indicator states from the set of transmission configuration indicator states; and
the subset comprises one or both of the two transmission configuration indicator states.

17. The method of claim 15, wherein the transmission configuration indicator state selection parameter indicates a single transmission configuration indicator state or two transmission configuration indicator states to be applied for receipt of the second physical downlink channel.

18. The method of claim 15, further comprising:
receiving a third control message that indicates a threshold time period for determining whether to include one or more transmission configuration indicator states indicated by the transmission configuration indicator state selection parameter in the subset of transmission configuration indicator states for receipt of the second physical downlink channel; and
determining that a time period between a first time at which the second control message is received and a current time is greater than or equal to the threshold time period, wherein the subset of transmission configuration indicator states comprises the one or more transmission configuration indicator states indicated by the transmission configuration indicator state selection parameter based at least in part on the time period being greater than or equal to the threshold time period.

19. The method of claim 15, further comprising:
receiving a third control message that indicates a threshold time period for determining whether to include one or more transmission configuration indicator states indicated by the transmission configuration indicator state selection parameter in the subset of transmission configuration indicator states for receipt of the second physical downlink channel; and
determining that a time period between a first time at which the second control message is received and a current time is less than the threshold time period, wherein the subset of transmission configuration indicator states comprises one or more default transmission configuration indicator states based at least in part on the time period being less than the threshold time period, the one or more default transmission configuration indicator states configured for the second physical downlink channel.

20. The method of claim 12, wherein the first control message indicates the first parameter and excludes the second parameter, and wherein receiving each of the first physical downlink channel and the second physical downlink channel comprises:
receiving the first physical downlink channel using all of the one or more transmission configuration indicator states indicated by the second control message based at least in part on the first single-frequency network communication scheme indicated by the first parameter; and
receiving the second physical downlink channel using a subset of transmission configuration indicator states based at least in part on exclusion of the second parameter from the first control message.

21. The method of claim 12, wherein receiving each of the first physical downlink channel and the second physical downlink channel comprises:
receiving both the first physical downlink channel and the second physical downlink channel using a single transmission configuration indicator state based at least in part on the second control message indicating the single transmission configuration indicator state.

22. The method of claim 12, further comprising:
transmitting a capability message indicating a capability of the UE to support single-frequency network communications with multiple transmission and reception points, wherein the second control message indicates two or more transmission configuration indicator states based at least in part on the capability message.

23. The method of claim 12, wherein the first control message comprises a radio resource control message and the second control message comprises downlink control information.

24. The method of claim 12, wherein receiving each of the first physical downlink channel and the second physical downlink channel comprises:
receiving both the first physical downlink channel and the second physical downlink channel from two or more transmission and reception points.

25. The method of claim 12, wherein the first physical downlink channel comprises a first type of physical downlink channel and the second physical downlink channel comprises a second type of physical downlink channel that is different than the first type of physical downlink channel, each of the first type and the second type selected from one of a physical downlink control channel or a physical downlink shared channel.

26. A method for wireless communication at a network entity, comprising:
transmitting a first control message comprising a parameter that indicates a single-frequency network communication scheme applicable to both a first physical downlink channel and a second physical downlink channel;
transmitting a second control message indicating a set of one or more transmission configuration indicator states from a plurality of transmission configuration indicator states; and
transmitting the first physical downlink channel and the second physical downlink channel in accordance with a subset of one or more transmission configuration indicator states, the subset of one or more transmission configuration indicator states selected from the set of one or more transmission configuration indicator states based at least in part on the single-frequency network communication scheme indicated by the parameter.

27. The method of claim 26, wherein the single-frequency network communication scheme corresponds to a first single-frequency network communication scheme of a plurality of single-frequency network communication schemes, and wherein transmitting the first physical downlink channel and the second physical downlink channel comprises:
transmitting both the first physical downlink channel and the second physical downlink channel in accordance with each transmission configuration indicator state of the set of one or more transmission configuration indicator states indicated by the second control message based at least in part on the first single-frequency network communication scheme.

28. A method for wireless communication at a network entity, comprising:
transmitting a first control message indicating a first parameter associated with a first single-frequency network communication scheme applicable to a first physical downlink channel, or a second parameter associated with a second single-frequency network communication scheme applicable to a second physical downlink channel, or both;
transmitting a second control message that indicates one or more transmission configuration indicator states from a set of transmission configuration indicator states; and
transmitting each of the first physical downlink channel and the second physical downlink channel in accordance with at least one transmission configuration indicator state of the one or more transmission configuration indicator states based at least in part on the first single-frequency network communication scheme indicated by the first parameter, the second single-frequency network communication scheme indicated by the second parameter, or both.

29. The method of claim 28, wherein the first control message indicates the first parameter and the second parameter, and wherein transmitting each of the first physical downlink channel and the second physical downlink channel comprises:
transmitting the first physical downlink channel in accordance with all of the one or more transmission configuration indicator states based at least in part on the first single-frequency network communication scheme indicated by the first parameter; and
transmitting the second physical downlink channel in accordance with all of the one or more transmission configuration indicator states based at least in part on the second single-frequency network communication scheme indicated by the second parameter.

30. An apparatus for wireless communication at a user equipment (UE), comprising:
a processor;
memory coupled with the processor; and
instructions stored in the memory and executable by the processor to cause the apparatus to:
receive a first control message comprising a parameter that indicates a single-frequency network communication scheme applicable to both a first physical downlink channel and a second physical downlink channel;
receive a second control message indicating a set of one or more transmission coniguration indicator states from a plurality of transmission configuration indicator states, and
receive the irst physical downlink channel and the second physical downlink channel using a subset of one or more transmission configuration indicator states, the subset of one or more transmission configuration indicator states selected from the set of one or more transmission configuration indicator states based at least in part on the single-frequency network communication scheme indicated by the parameter.

31. The apparatus of claim 30, wherein the single-frequency network communication scheme corresponds to a first single-frequency network communication scheme of a plurality of single-frequency network communication schemes, and wherein the instructions to receive the first physical downlink channel and the second physical downlink channel are executable by the processor to cause the apparatus to:
receive both the first physical downlink channel and the second physical downlink channel using each transmission configuration indicator state of the set of one or more transmission coniguration indicator states indicated by the second control message based at least in part on the first single-frequency network communication scheme.

32. The apparatus of claim 31, wherein a codepoint indicated by the second control message comprises two transmission coniguration indicator states from the plurality of transmission coniguration indicator states.

33. The apparatus of claim 30, wherein the single-frequency network communication scheme corresponds to a second single-frequency network communication scheme of a plurality of single-frequency network communication schemes, and wherein the instructions to receive the first physical downlink channel and the second physical downlink channel are executable by the processor to cause the apparatus to:
receive both the first physical downlink channel and the second physical downlink channel using a first set of quasi co-location parameters associated with a first transmission configuration indicator state of the set of one or more transmission configuration indicator states and a second set of one or more quasi co-location parameters associated with a second transmission configuration indicator state of the set of one or more transmission configuration indicator states based at least in part on the second single-frequency network communication scheme, wherein the second set of one or more quasi co-location parameters excludes one or more quasi co-location parameters.

34. The apparatus of claim 30, wherein the instructions to receive the first physical downlink channel and the second physical downlink channel are executable by the processor to cause the apparatus to:
receive both the first physical downlink channel and the second physical downlink channel using a single transmission configuration indicator state based at least in part on the second control message indicating the single transmission configuration indicator state.

35. The apparatus of claim 30, wherein the instructions are further executable by the processor to cause the apparatus to:
transmit a capability message indicating a capability of the UE to support single-frequency network communications with multiple transmission and reception points, wherein the second control message indicates a codepoint that comprises one or more transmission configuration indicator states from the plurality of transmission configuration indicator states based at least in part on the capability message.
